(19) United States
(12) Patent Application Publication
(10) Pub. No.: US 2021/0336254 A1
(43) Pub. Date: Oct. 28, 2021

(54) METAL AND METAL-ALLOY BASED BATTERIES

(71) Applicant: AB SYSTEMS, INC. (US), Palo Alto, CA (US)

(72) Inventors: Chun-Jern PAN, Palo Alto, CA (US); Meng-Chang LIN, Palo Alto, CA (US); Hongjie DAI, Palo Alto, CA (US)

(21) Appl. No.: 17/271,196

(22) PCT Filed: Aug. 27, 2019
(86) PCT No.: PCT/US2019/048405

§ 371 Date: Feb. 24, 2021

Related U.S. Application Data
(60) Provisional application No. 62/723,431, filed on Aug. 27, 2018.

(51) Int. Cl. H01M 4/46; H01M 10/44; H01M 10/36

(52) U.S. Cl. CPC H01M 4/463; H01M 2300/0057; H01M 10/36; H01M 10/44

(57) ABSTRACT

Provided herein are methods for making a metal and metal-alloy anode battery having electrolytes which include Al—Cl₄¹⁻ and are free of any Al₂Cl₇⁻¹ anions. These batteries are observed to have improved electrochemical performance. Also set forth herein are electrolytes include AlCl₄¹⁻ and are free of any Al₂Cl₇¹⁻ anions. Also set forth herein are electrochemical cells which include electrolytes which include AlCl₄¹⁻ and are free of any Al₂Cl₇¹⁻ anions.

### FIELD

This application claims the benefit of priority to U.S. Provisional Patent Application No. 62/723,431, filed Aug. 27, 2018, the entire contents of which are herein incorporated by reference in their entirety for all purposes.

The present disclosure concerns rechargeable (i.e., secondary) batteries as well as methods of making and using the same. In some examples, the present disclosure concerns rechargeable batteries such as, but not limited to, rechargeable batteries having a metal and metal alloy anode (i.e., Al—Li, Zn—Li—Al, Al—Zn, Zn—Li, Sn—Li, negative electrode).

### BACKGROUND

A battery's energy density is related to the electrochemical potential difference for an atom (e.g., Li) in the anode relative to the corresponding ion (e.g., Li⁺) in the cathode. A rechargeable battery's energy density is therefore maximized when the anode is a single metal. The electrochemical potential for a metal atom in a metal made of identical atoms that is 0 V. Thus, metal anodes as compared to intercalation anodes (e.g., Li₆C or lithium titanate) maximize the energy difference between the anode and any cathode. Therefore, to increase the energy density of current batteries, as well as for safety and economic reasons, metal anode rechargeable batteries are desired.

Aluminum (Al) is an attractive metal for a metal anode rechargeable battery. The three-electron redox properties of Al provides a theoretical gravimetric capacity as high as 2,980 mAh/g and a volumetric capacity as high as 804 Ah cm⁻³, when paired with a carbon-containing cathode. Al is also the third most abundant element in the Earth's crust. Al is generally less reactive than other metal anodes [e.g., lithium (Li) and sodium (Na)] and is easier to process. Al is therefore an economically viable choice for large scale battery manufacturing and, for example, grid storage applications.

Key to commercializing Al-metal anode rechargeable batteries, is the development of electrolytes which are chemically compatible with Al and which are sufficiently ionically conductive. Also critical is the development of electrolytes that can be paired with lithium-intercalating cathode active materials. Some researchers have developed Al-metal anode rechargeable batteries and used ionic liquid or deep eutectic electrolytes which included, or were prepared using, electrolyte mixtures of AlCl₃ and 1-ethyl-3-methylimidazolium chloride (EMIMC) or mixtures of AlCl₃ and urea. See, for example, US Patent Application Publication No. 2015-0249261; Lin, M C, et al., Nature, 2015, doi:1038/nature143040; and Angell, et al., PNAS, Early Edition, 2016, p. 1-6, doi:10.1073/pnas.1619795114, the entire contents of each of which are herein incorporated by reference in their entirety for all purposes. See also Carlin, et al., Journal of Applied Electrochemistry, 26 (1996) 1147-1160; Xie, et al., Journal of The Electrochemical Society, 147 (11) 4247-4251 (2000); Cheng, et al., Chem. Commun., 2014, 50, 9644; Yoo, et al., ChemElectroChem 2017, 4, 1-8; available as https://doi.org/10.1002/celc.201700271; Sun, et al., DOI: 10.1039/c5cc09019a; Riechel, et al., J. Electrochem. Soc., Vol. 140, No. 11, November 1993; Piersma, B, Electrochemistry of Lithium in Room Temperature Molten Salt Electrolytes, DOI: 10.1149/199413.0415PV ; and Piersma, B, J. Electrochem. Soc., Vol. 143, No. 3, March 1996, the entire contents of each of which are herein incorporated by reference in their entirety for all purposes.

The pure Al-metal batteries with ionic liquid or deep eutectic solvent electrolytes have been prepared suffer from disadvantages including low energy density, and sensitivity to water, causing instability problems. Trace amounts of water in these electrolytes are difficult to remove and can form hydrochloric acid (HCl), hydrogen gas (H₂) and carbon dioxide (CO₂). If these by-products are sealed in an Al-metal or Al-alloy battery, they can result in corrosion, deformation, or destruction of the battery or its packaging. Another problem with Al-metal batteries in ionic liquid or deep eutectic solvent electrolytes is the electrolyte is highly acidic, containing Al₂Cl₇_{^{−}} species that can cause severe corrosion problems to electrodes and cell enclosures.

In view of these as well as other unmet challenges, there exists a need for improved metal anode rechargeable batteries, including Al-metal and Al-alloy anode rechargeable batteries.

### SUMMARY

In one embodiment, set forth herein is an electrochemical cell, comprising: (i) an electrolyte, wherein the electrolyte comprises: (a) AlCl₄¹⁻; (b) Li⁺; and (c) at least one member selected from the group consisting of organic cations and organic-metal complex cations; (d) wherein the electrolyte is free of any Al₂Cl₇¹⁻ (as detected by Raman spectroscopy); (ii) a metal anode comprising a metal or alloy selected from the group consisting of aluminum (Al), lithium (Li), Al—Li, nickel (Ni), tungsten (W), titanium (Ti), sodium (Na), zinc (Zn), Al—Zn, copper (Cu), Al—Li—Zn, Zn—Al and tin (Sn); and (iii) a cathode, wherein the cathode is redox-active to at least one intercalation species selected from the group consisting of Li⁺, Na⁺, K³⁰ , and AlCl₄¹⁻. In some examples, the metal anode comprises a metal or alloy with a metal or an alloy coating thereupon.

In a second embodiment, set forth herein is an electrochemical cell, comprising: (i) an electrolyte, wherein the electrolyte comprises: (a) AlCl₄¹⁻; (b) Li⁺; and (c) at least one member selected from the group consisting of organic cations and organic-metal complex cations; (d) wherein the electrolyte is free of any Al₂Cl₇¹⁻ (as detected by Raman spectroscopy); (ii) a metal anode comprising a metal or alloy selected from the group consisting of aluminum (Al), lithium (Li), Al—Li alloy, nickel (Ni), tungsten (W), titanium (Ti), sodium (Na), zinc (Zn), magnesium (Mg), Al—Mg alloy, Al—Zn alloy, Al—Zn—Mg alloy, copper (Cu), Al—Li—Zn alloy, Zn—Al alloy, CuZn alloy, and tin (Sn); and (iii) a cathode, wherein the cathode is redox-active to at least one intercalation species selected from the group consisting of Li⁺, Na⁺, K⁺, and AlCl₄¹⁻. In some examples, the metal anode comprises a metal or alloy with a metal or an alloy coating thereupon.

In a third embodiment, set forth herein is an electrochemical cell, comprising: (i) an electrolyte, wherein the electrolyte comprises: (a) AlCl₄¹⁻; (b) Li⁺; and (c) at least one member selected from the group consisting of organic cations and organic-metal complex cations; (ii) a metal anode comprising a metal or alloy selected from the group consisting of aluminum (Al), lithium (Li), Al—Li alloy, nickel (Ni), tungsten (W), titanium (Ti), sodium (Na), zinc (Zn), magnesium (Mg), Al—Mg alloy, Al—Zn alloy, Al—Zn—Mg alloy, copper (Cu), Al—Li—Zn alloy, Zn—Al alloy, CuZn alloy, and tin (Sn); (iii) a cathode, wherein the cathode is redox-active to at least one intercalation species selected from the group consisting of Li⁺, Na⁺, K⁺, and AlCl₄¹⁻; and (iv) at least one member selected from the group consisting of LiF, Li₂O, and combinations thereof. In some examples, the metal anode comprises a metal or alloy with a metal or an alloy coating thereupon.

In fourth embodiment, set forth herein is an electrochemical cell, comprising: (i) an electrolyte, wherein the electrolyte comprises: (a) AlCl₄¹⁻; (b) Li⁺; and (c) at least one member selected from the group consisting of organic cations and organic-metal complex cations; (ii) a metal anode comprising a metal or alloy selected from the group consisting of aluminum (Al), lithium (Li), Al—Li alloy, nickel (Ni), tungsten (W), titanium (Ti), sodium (Na), zinc (Zn), magnesium (Mg), Al—Mg alloy, Al—Zn alloy, Al—Zn—Mg alloy, copper (Cu), Al—Li—Zn alloy, Zn—Al alloy, CuZn alloy, and tin (Sn); (iii) a cathode, wherein the cathode is redox-active to at least one intercalation species selected from the group consisting of Li⁺, Na⁺, K⁺, and AlCl₄¹⁻; and (iv) wherein the electrolyte has a mole ratio of Al₂Cl₇⁻:AlCl₄⁻ of 0.12 or less. In some examples, the metal anode comprises or metal or alloy with a metal or an alloy coating thereupon. In some examples, the ratio of Al₂Cl₇⁻:AlCl₄⁻ that is 0 to 0.05.

In a fifth embodiment, set forth herein is an electrochemical cell, comprising: an electrolyte, wherein the electrolyte comprises: (a) AlCl₄¹⁻; (b) Li⁺; and (c) at least one member selected from the group consisting of organic cations and organic-metal complex cations; (d) wherein the electrolyte is free of any Al₂Cl₇¹⁻; (e) wherein the electrolyte is further doped with an additive selected from LiF, Li₂O and combinations thereof.

In a sixth embodiment, set forth herein is a process for making an electrolyte, wherein the electrolyte comprises: AlCl₄¹⁻; Li⁺; at least one member selected from the group consisting of organic cations and organic-metal complex cations; wherein the electrolyte is free of any Al₂Cl₇¹⁻; and wherein the electrolyte is further doped with an additive selected from the group consisting of LiF, Li₂O, and combinations thereof; the process comprising contacting the electrolyte with aluminum metal in the presence of an additive selected from SnCl₂, GaCl₃, and combinations thereof.

In a seventh embodiment, set forth herein an electrolyte, comprising: (a) AlCl₄¹⁻; (b) Li⁺; (c) at least one member selected from the group consisting of organic cations and organic-metal complex cations; (d) wherein the electrolyte is free of any Al₂Cl₇¹⁻; (e) an additive selected from the group consisting of LiF, Li₂O, and combinations thereof; and (f) wherein the electrolyte is made by contacting the electrolyte with aluminum metal in the presence of an additive selected from SnCl₂, GaCl₃, and combinations thereof.

In an eighth embodiment, set forth herein is a process for making an electrolyte, comprising contacting (i) AlCl₃ with: (ii) an organic cation or organic-metal complex cation, wherein the organic cation is selected from the group consisting of urea ions, imidazolium ions, ammonium ions, pyrrolidinium ions, pyridinium ions, phosphonium ions, and combinations thereof; and (iii) a saturated amount of a halide of a metal selected from the group consisting of Li, Na, K, Ca, Mg, Zn, Cu, and combinations thereof.

### BRIEF DESCRIPTIONS OF THE DRAWINGS

FIG. 1 shows the electrochemical performance (Specific capacity (left y-axis) and Coulombic efficiency (right axis) as a function of cycle number (x-axis)) of the Al—LiFePO₄ electrochemical cell described in Example 1. FIG. 1(a) show the results of the cell prepared using a saturated amount of LiCl and an AlCl₃:EMIMC (1.3:1 mol/mol) electrolyte. FIG. 1(b) show the results of the cell prepared using a saturated amount of LiCl and an AlCl₃: Et₃NHCl (1.7:1 mol/mol) electrolyte. FIG. 1(c) show the results of the cell prepared using a saturated amount of LiCl and an AlCl₃:Urea (1.3:1 mol/mol) electrolyte. Et₃NHCl=Triethylamine hydrochloride.

FIG. 2 shows the electrochemical performance (Specific capacity (left y-axis) and Coulombic efficiency (right axis) as a function of cycle number (x-axis)) of the Al—LiNiCoMnO₂ electrochemical cell described in Example 2. FIG. 2(a) show the cell prepared using a saturated amount of LiCl and an AlCl₃:EMIMC (1.1:1 mol/mol) electrolyte. FIG. 2(b) show the cell prepared using a saturated amount of LiCl and an AlCl₃:Urea (1.3:1 mol/mol) electrolyte.

FIG. 3 shows the electrochemical performance (Specific capacity (left y-axis) and Coulombic efficiency (right axis) as a function of cycle number (x-axis)) of the Al-graphite electrochemical cell described in Example 3. FIG. 3(a) show the cell with 200 μm glass separator, which was prepared using an AlCl₃:EMIMC (1.6:1 mol/mol) electrolyte with Mg²⁺. FIG. 3(b) show the cell with 200 μm glass separator, which was prepared using an AlCl₃:Et₃NHCl (1.6:1 mol/mol) electrolyte with Cu²⁺. TIL in FIG. 3 is an abbreviation for Et₃NHCl, or Triethylamine hydrochloride.

FIG. 4 shows the electrochemical performance (Specific capacity (left y-axis) and Coulombic efficiency (right axis) as a function of cycle number (x-axis)) of the Ni—LiFePO₄ electrochemical cell described in Example 4. The cell was prepared using a saturated amount of LiCl with an AlCl₃:Et₃NHCl (1.7:1 mol/mol) electrolyte.

FIG. 5 shows electrochemical performance (Specific capacity (left y-axis) and Coulombic efficiency (right axis) as a function of cycle number (x-axis)) of the Zn-LiFePO₄ electrochemical cell described in Example 5. The cell was prepared using a saturated amount of LiCl in an AlCl₃:Et₃NHCl (1.7:1 mol/mol) electrolyte.

FIG. 6 shows electrochemical performance ((Specific capacity (left y-axis) and Coulombic efficiency (right axis) as a function of cycle number (x-axis)) of the 7075 type Al—Zn—Mg-alloy-LiFePO₄ electrochemical cell described in Example 6. The 7075 type alloy included Al with 5.5 weight percent (wt %) Zn and 2.5 wt % Mg. The cell was prepared using a saturated amount of LiCl in an AlCl₃:Et₃NHCl (1.7:1 mol/mol) electrolyte.

FIG. 7 shows Raman spectroscopy analysis of an electrolyte having a mole ratio of AlCl₃:EMIC of 1.1, as set forth in Example 7.

FIG. 8 shows Raman spectroscopy analysis of the series of electrolytes set forth in Example 8.

FIG. 9 shows a comparison plot of the results of electrochemically cycling the electrochemical cells sets forth in Example 9.

FIG. 10 shows electrochemical performance (Specific capacity (left y-axis) and Coulombic efficiency (right axis) as a function of cycle number (x-axis)) of the first electrochemical cell described in Example 9.

FIG. 11 shows electrochemical performance (Specific capacity (left y-axis) and Coulombic efficiency (right axis) as a function of cycle number (x-axis)) of the second electrochemical cell described in Example 9.

FIG. 12 shows an x-ray photoelectron spectroscopy results for the anode of the electrochemical cell as described in Example 10.

FIG. 13 shows an x-ray photoelectron spectroscopy results for the anode of the electrochemical cell as described in Example 10.

FIG. 14 shows scanning electron microscopy results for the anode of the electrochemical cell as described in Example 10.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the inventions herein are not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. General

Set forth herein are processes for making new electrolytes, e.g., mixing AlCl₃:EMIMC in a 1.5 molar ratio while adding saturated amounts of LiCl thereto.

According to Equation [1], adding LiCl converts Al₂Cl₇¹⁻ completely into AlCl₄¹⁻ and Li⁺ ions:

Al₂Cl₇¹⁻+LiCl(ₛ)→2AlCl₄¹⁻+Li⁺ [1]

These Li⁺ ions can then be used to perform Li-metal (e.g., Al, Zn, Ni, Sn, Cu, W, Ca, K) alloy redox on the metal anode, and Li/Li⁺ redox in a cathode active material, e.g., LiFePO₄ also known as LFP. The following equations [2]-[3] demonstrate this:

Li-metal alloy=Li⁺+metal+e⁻ [2]

In Equation [2], Li-metal alloy in the anode oxidizes to Li⁺ and metal, which releases an electron, i.e., e⁻. This would occur during a discharge cycle.

The lithium ions (Li⁺) produced in Equations [2] can then intercalate into a redox-active cathode material, e.g., lithium iron phosphate, or iron phosphate, according to Equation [4]:

Li⁺+e−+FePO₄=LiFePO₄ [3]

By using a saturated amount of LiCl in the AlCl₄¹⁻ containing electrolyte, the instant disclosure, to the best of the inventor's knowledge, was the first to avoid Al₂Cl₇¹⁻ in the electrolyte and thus set forth a Li-metal alloy batteries operating according to Equations [1]-[3], which has a comparatively increased specific capacity of up to 140 mAh/g and Coulombic efficiency up to 99.9%. The halide-saturation and Al₂Cl₇¹⁻ free nature of the electrolyte differ from any previous ionic liquid based batteries. This type of electrolyte is unique and would not have been expected to function as electrolyte since Al would not deposit at the anode without this anion. Surprisingly, the electrolytes described herein work well with anodes which include Al.

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “about,” when qualifying a number, e.g., 100° C., refers to the number qualified and optionally the numbers included in a range about that qualified number that includes ±10% of the number. For example, about 100° C. includes 100° C. as well as 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., and 110° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including an anode and a cathode, which have ionic communication between the two using an electrolyte.

As used herein, the terms “cathode” and “anode” refer to the electrodes of a battery. In some examples, the anode of an Al-metal anode battery includes Al or an alloy thereof. In some examples herein, the cathode includes graphite or lithium iron phosphate. During charging, in some examples, AlCl₄¹⁻ ions de-intercalate from the graphite and conduct through the electrolyte to eventually plate out Al at the anode. During discharging, Al₂Cl₇¹⁻ ions dissolve from the Al anode and completely convert into AlCl₄¹⁻ ions in the electrolyte due to saturated amounts of LiCl. The AlCl₄¹⁻ ions conducts through the electrolyte and eventually intercalate in the graphite in the cathode. Additional battery chemistries may be operable depending on the cathode active material employed. For example, if the graphite in the cathode is substituted for LiFePO₄, then Li⁺ ions can intercalate and de-intercalate from the cathode (instead of AlCl₄¹⁻ ions intercalating and de-intercalating into graphite). During a charge cycle, electrons leave the cathode and move through an external circuit to the anode. During a discharge cycle, electrons leave the anode and move through an external circuit to the cathode. Unless otherwise specified, the cathode refers to the positive electrode. Unless otherwise specified, the anode refers to the negative electrode.

As used here, the phrase “direct contact,” refers to the juxtaposition of two materials such that the two materials contact each other sufficiently to conduct either an ion or electron current. As used herein, direct contact refers to two materials in contact with each other and which do not have any materials positioned therebetween.

As used herein, the term “separator,” refers to the physical barrier which electrically insulates the anode and the cathode from each other. The separator is often porous so it can be filled or infiltrated with an electrolyte. The separator is often mechanically robust so it can withstand the pressure applied to the electrochemical cell. Example separators include, but are not limited to, SiO₂ glass fiber separators or SiO₂ glass fiber mixed with a polymer fiber or mixed with a binder.

As used herein, the term “ electrolyte” or “electrolyte,” refers to nonflammable electrolytes which include a mixture of a strong Lewis acid metal halide and Lewis base ligand. Examples include, but are not limited to, electrolytes prepared using AlCl₃ and 1-ethyl-3-methylimidazolium chloride ([EMIm]Cl). Example Lewis base ligands include, but are not limited to, urea, acetamide, or 4-propylpyridine. In a typical electrolyte having AlCl₃ as a metal halide, AlCl₃ undergoes asymmetric cleavage to form a tetrachloroaluminate anion (AlCl₄¹⁻) and an aluminum chloride cation (AlCl₂⁺) in which a ligand is datively bonded to (or associated through coordination via sharing of lone pair electrons) the AlCl₂⁺ cation, forming ([AlCl₂n(ligand)]⁺). These mixtures are useful as electrolytes for Al-metal anode batteries. Examples include, but are not limited to, mixtures of AlCl₃ and 1-ethyl-3-methylimidazolium chloride (EMIMC), mixtures of AlCl₃ and urea, mixtures of AlCl₃ and acetamide, mixtures of AlCl₃ and 4-propylpyridine, and mixtures of AlCl₃ and trimethylphenylammonium chloride. These electrolyte may further comprise LiCl or any oxidation species of Li, Na, Ca, Cu, K, Mg, and combinations thereof.

As used herein, the term “deep eutectic solvent,” “deep eutectic solvent electrolyte,” or “DES,” refers to a mixture of a strong Lewis acid metal halide and a Lewis base ligand. See, for example, Hogg, J M, et al., Green Chem 17(3):1831-1841; Fang, Y, et al., Electrochim Act 160:82-88; Fang, Y, et al., Chem. Commun. 51(68)13286-13289; and also Pulletikurthi, G., et al., Nature, 520(7547):325-328 for a non-limiting set of example DES mixture. The content of each of these references in herein incorporated by reference in its entirety for all purposes. Examples include, but are not limited to, AlCl₃ and urea.

As used herein, the term “chemically compatible enclosure,” refers to an enclosure which physically contains an anode, cathode, separator and electrolyte without resulting in a substantial amount of corrosion. A substantial amount of corrosion includes an amount which degrades the Coulombic efficiency of a battery by more than 10% or which reduces its capacity by more than 10%. Chemical compatibility is considered with respect to the reactivity of a material and an electrolyte or DES. A material which reacts with an electrolyte or DES and degrades the Coulombic efficiency of a battery by more than 10% or which reduces its capacity by more than 10%, is not chemically compatible, as the phrase is used herein. Chemically compatible enclosures herein do not include Swage-log battery cells, plastic pouches or sealed glass battery cells. A non-limiting example of a chemically compatible enclosure is a FEP pouch surrounding a cathode, anode and electrolyte or DES. Surrounding the FEP pouch is a second multilayered pouch in which the multilayered pouch walls comprise sequential layers of a polyamide polymer layer/an adhesive layer/an aluminum layer/adhesive layer/and a polypropylene polymer layer. In some examples, the polyamide polymer layer is the outer-most layer of the pouch. In some examples, the inner layer, which contacts the FEP pouch, is the polypropylene layer. When viewed from the outside the polyamide layer is visible, in some examples. In some examples, under the polyamide layer is an adhesive. In some examples, under the adhesive is an aluminum layer. In some examples, under the aluminum layer is another adhesive. In some examples, under the another adhesive is the polypropylene layer. In some examples, under the polypropylene layer is the FEP pouch. And inside the FEP pouch, in some examples, is the cathode, anode, and electrolyte (or DES).

As used herein, the term “metal halide salt,” refers to a salt which includes at least one metal atom and at least one halogen atom. Examples include, but are not limited to, LiCl, NaCl, KCl, MgCl₂, CaCl₂, CuCl₂, CuCl, AlF₃, AlCl₃, AlBr₃, AlI₃, and combinations thereof.

As used herein, the term “graphitized,” refers to a material which includes graphite.

As used herein, the term “crystalline,” refers to a material which diffracts x-rays. Crystalline graphite is characterized by at least an XRD peak at 26.55 2 Θ (the (002) peak of graphite having a d-spacing of 3.35 Å). Graphite is mined as either vein, flake, or microcrystalline. Herein, graphite can be vein, flake microcrystalline, or a combination thereof. In some examples, the graphite is flake graphite. In some examples, the graphite is natural flake graphite.

As used herein, the term “few defects,” refers to graphite that has less than 5% defects per mole. Defects include, but are not limited to, misshaped particles, amorphous carbon, or particles having a particle size other than the average particle size. Defects in graphite can be measured using Raman spectroscopy and comparing the defect D band intensity relative to the graphite G band. In some examples, the ratio D/G is about near zero for natural graphite with few defects. In some examples, the ratio D/G is about zero for natural graphite with few defects.

As used herein, “pouch,” is used interchangeably with the phrase “prismatic cell.”

As used herein, the term “cycling,” refers to an electrochemical process whereby an electrochemical cell having an anode and a cathode is charged and discharged.

As used herein, the term “C-rate” refers to a measure of the rate at which a battery is discharged relative to its maximum capacity. A 1 C rate means that the discharge current will discharge the entire battery in 1 hour. For a battery with a capacity of 100 Amp-hrs, a 1C rate equates to a discharge current of 100 Amps.

As used herein, the phrase “free of any Al₂Cl₇¹⁻,” means that the concentration of Al₂Cl₇¹⁻ in the electrolyte is less than the amount required to detect Al₂Cl₇¹⁻ empirically using either Raman spectroscopy, infrared spectroscopy, mass spectroscopy, atomic emission spectroscopy, or inductively coupled plasma spectroscopy. Unless stated otherwise or to the contrary, the phrase “free of any Al₂Cl₇¹⁻,” means that the concentration of Al₂Cl₇¹⁻ in the electrolyte is less than the amount required to detect Al₂Cl₇¹⁻ empirically using Raman spectroscopy.

As used herein, the phrase “present at least at a detectable limit,” means that the species present can be detected empirically. A variety of techniques known in the art can be used to detect species, e.g., Raman spectroscopy, infrared spectroscopy, mass spectroscopy, atomic emission spectroscopy, or inductively coupled plasma spectroscopy. Unless specified otherwise or to the contrary, “present at least at a detectable limit,” means that the species present is detected empirically as determined by Raman spectroscopy.

As used herein, the phrase “ionically conductive” refers to a media or material which conducts ions (e.g., Li⁺ or AlCl₄¹⁻ ions with a conductivity of at least 1*10⁴ S/cm² or greater).

As used herein, the phrase “redox-active to at least one intercalation species selected from the group consisting of Li⁺, Na⁺, K⁺, and AlCl₄¹⁻” refers to a material, known as a cathode active material, which can intercalate and de-intercalate any one of Li⁺, Na⁺, K⁺, and AlCl₄¹⁻ and also undergo a change in redox state during the intercalation or de-intercalation of any one of Li⁺, Na⁺, K⁺, and AlCl₄¹⁻. Redox-active materials include, but are not limited to graphite, LiCoO₂, LiMn₂O₄, LiMn_{1.5}Ni_{0.5}O₄, Li(NiCoAl)O₂ (NCA), Li(NiCoMn)O₂ (NMC), lithium iron phosphate (LiFePO₄), lithium nickel phosphate (LiNiPO₄), lithium cobalt phosphate (LiCoPO₄), lithium manganese phosphate (LiMnPO₄), lithium cobalt oxide, lithium manganese cobalt oxide, lithium nickel manganese cobalt oxide, lithium nickel manganese oxide and sulfur.

### Chemistry

In some examples, an electrochemical cell includes an Al or Al-alloy anode and a graphite-including cathode or a LiFePO₄-including cathode. In some examples, a LiFePO₄ (LFP) cathode can be substituted for the graphite-including cathode. During a discharging reaction, in some examples, AlCl₄¹⁻ intercalates into graphite as carbon is oxidized. Alternatively, and in some examples, during discharging, Li⁺ intercalates into LFP. In some of the examples, herein, the mole ratio of AlCl₃:[EMIm]Cl is about 1.3:1, 1.4:1, 1.5:1, 1.6:1, 1.7:1, 1.8:1, or 1.9:1 unless specified otherwise. When a saturated about of LiCl is introduced, the amount of Al₂Cl₇¹⁻ is reduced below a detectable limit because it completely converts to AlCl₄¹⁻. Furthermore, the Li⁺ produced by the addition of a saturated amount of LiCl can then be used to intercalate into a cathode other than a graphite-including cathode, for example a LiFePO₄ cathode.

In some other examples, electrolytes can be formed by slowly mixing or otherwise combining an aluminum halide (e.g., AlCl₃) and an organic compound (e.g., EMIMC, Et₃NHCl, and urea). In certain examples, the aluminum halide undergoes asymmetric cleavage to form a haloaluminate anion (e.g., AlCl₄¹⁻) and an aluminum halide cation that is datively bonded to the organic compound serving as a ligand (e.g., [AlCl₂ n(ligand)]+). A mole ratio of the aluminum halide and the organic compound can be at least or greater than about 1.1 or at least or greater than about 1.2, and is up to about 1.5, up to about 1.8, up to about 2, or more. In some examples, the molar ratio, mᵣ, is 1<mᵣ<2. For example, the mole ratio the aluminum halide and the organic compound (e.g., urea) can be in a range of about 1.1 to about 1.7 or about 1.3 to about 1.5. In some embodiments, a ligand is provided as a salt or other compound including the ligand, and a mole ratio of the aluminum halide and the ligand-containing compound can be at least or greater than about 1.1 or at least or greater than about 1.2, and is up to about 1.5, up to about 1.8, up to about 2, or more. An electrolyte can be doped, or have additives added, to increase its electrical conductivity and lower the viscosity, or can be otherwise altered to yield compositions that favor the reversible electrodeposition/electrodissolution of metals. For example, 1,2-dichlorobenzene can be added as a co-solvent to reduce electrolyte viscosity and increase the voltage efficiency, which can result in an even higher energy density. Also, alkali chloride additives can be added to increase the discharge voltage of a battery. In some examples, 1-ethyl-3-methylimidazolium tetrafluoroborate or 1-ethyl-3-methylimidazolium bis(trifluoromethane sulfonimide) or 1-ethyl-3-methylimidazolium hexafluorophosphate can be added as additives to increase the discharge voltage of a battery.

After mixing the aforementioned reagents, in some examples, the electrolyte is exposed to Cu metal.

After mixing the aforementioned reagents, in some examples, the electrolyte is exposed to Zn metal.

After mixing the aforementioned reagents, in some examples, the electrolyte is exposed to Ca metal.

After mixing the aforementioned reagents, in some examples, the electrolyte is exposed to Li metal.

After mixing the aforementioned reagents, in some examples, the electrolyte is exposed to Na metal.

After mixing the aforementioned reagents, in some examples, the electrolyte is treated by contacting and reacting the electrolyte with aluminum metal in the presence of an additive selected from SnCl₂, GaCl₃, and combinations thereof. In some examples, the electrolyte is further doped with an additive selected from LiF, LiO₂ and combinations thereof. In some examples, the electrolyte is further doped LiF. In some examples, the electrolyte is further doped Li₂O.

After mixing the aforementioned reagents, in some examples, the electrolyte is treated by contacting and reacting the electrolyte with aluminum metal in the presence SnCl₂. In some examples, the electrolyte is further doped with an additive selected from LiF, LiO₂ and combinations thereof. In some examples, the electrolyte is further doped LiF. In some examples, the electrolyte is further doped Li₂O.

After mixing the aforementioned reagents, in some examples, the electrolyte is treated by contacting and reacting the electrolyte with aluminum metal in the presence GaCl₃. In some examples, the electrolyte is further doped with an additive selected from LiF, LiO₂ and combinations thereof. In some examples, the electrolyte is further doped LiF. In some examples, the electrolyte is further doped Li₂O.

After mixing the aforementioned reagents, in some examples, the electrolyte is treated by contacting and reacting the electrolyte with aluminum metal in the presence of combinations of SnCl₂ and GaCl₃. In some examples, the electrolyte is further doped with an additive selected from LiF, LiO₂ and combinations thereof. In some examples, the electrolyte is further doped LiF. In some examples, the electrolyte is further doped Li₂O.

### Electrochemical Cells

In some examples, set forth herein is an electrochemical cell, including: (i)an electrolyte (electrolyte), wherein the electrolyte includes: (a) AlCl₄¹⁻, (b) Li⁺, (c) at least one member selected from the group consisting of organic cations and organic-metal complex cations; and (d) wherein the electrolyte is free of any Al₂Cl₇¹⁻; (ii) a metal anode including a metal, or alloy thereof, selected from the group consisting of aluminum (Al), lithium (Li), Al—Li, nickel (Ni), tungsten (W), titanium (Ti), sodium (Na), zinc (Zn), Al—Zn, copper (Cu), and tin (Sn); and (iii) a cathode, wherein the cathode is redox-active to at least one intercalation species selected from the group consisting of Li⁺, Na⁺, K⁺, and AlCl₄¹⁻.

In some examples, set forth herein is an electrochemical cell, including: (i) an electrolyte (electrolyte), wherein the electrolyte includes: (a) AlCl₄¹⁻, (b) Li⁺, (c) at least one member selected from the group consisting of organic cations and organic-metal complex cations; and (d) wherein the electrolyte is free of any Al₂Cl₇¹⁻; (ii) a metal anode including a metal, or alloy thereof, selected from the group consisting of aluminum (Al), lithium (Li), Al—Li alloy, nickel (Ni), tungsten (W), titanium (Ti), sodium (Na), zinc (Zn), magnesium (Mg), Al—Mg alloy, Al—Zn alloy, Al—Zn—Mg alloy, copper (Cu), Al—Li—Zn alloy, Zn—Al alloy, CuZn alloy, and tin (Sn); and (iii) a cathode, wherein the cathode is redox-active to at least one intercalation species selected from the group consisting of Li⁺, Na⁺, K⁺, and AlCl₄¹⁻.

In some examples, set forth herein is an electrochemical cell, including: (i) an electrolyte, wherein the electrolyte comprises: (a) AlCl₄¹⁻; (b) Li⁺; and (c) at least one member selected from the group consisting of organic cations and organic-metal complex cations; (ii) a metal anode including a metal or alloy selected from the group consisting of aluminum (Al), lithium (Li), Al—Li alloy, nickel (Ni), tungsten (W), titanium (Ti), sodium (Na), zinc (Zn), magnesium (Mg), Al—Mg alloy, Al—Zn alloy, Al—Zn—Mg alloy, copper (Cu), Al—Li—Zn alloy, Zn—Al alloy, CuZn alloy, and tin (Sn); (iii) a cathode, wherein the cathode is redox-active to at least one intercalation species selected from the group consisting of Li⁺, Na⁺, K⁺, and AlCl₄¹⁻; and (iv) at least one member selected from the group consisting of LiF, Li₂O, and combinations thereof. In some examples, the metal anode comprises or metal or alloy with a metal or an alloy coating thereupon. In certain examples, the electrochemical cell includes LiF. In certain other examples, the electrochemical cell includes Li₂O. In yet other certain examples, the electrochemical cell includes both LiF and Li₂O. Without being bound by theory, the Li₂O and LiF may increase the buffering effect and result in a neutral state with minimal amounts of Al₂Cl₇⁻. This may also result in an increase in coulombic efficiency and longer cycle life

In some examples, set forth herein is an electrochemical cell, comprising: (i) an electrolyte, wherein the electrolyte comprises: (a) AlCl₄¹⁻; (b) Li⁺; and (c) at least one member selected from the group consisting of organic cations and organic-metal complex cations; (ii) a metal anode comprising a metal or alloy selected from the group consisting of aluminum (Al), lithium (Li), Al—Li alloy, nickel (Ni), tungsten (W), titanium (Ti), sodium (Na), zinc (Zn), magnesium (Mg), Al—Mg alloy, Al—Zn alloy, Al—Zn—Mg alloy, copper (Cu), Al—Li—Zn alloy, Zn—Al alloy, CuZn alloy, and tin (Sn); (iii) a cathode, wherein the cathode is redox-active to at least one intercalation species selected from the group consisting of Li⁺, Na⁺, K⁺, and AlCl₄¹⁻; and (iv) wherein the electrolyte has a mole ratio of Al₂Cl₇⁻:AlCl₄⁻ of 0.12 or less. In some examples, the metal anode comprises or metal or alloy with a metal or an alloy coating thereupon. In some examples, the ratio of Al₂Cl₇⁻:AlCl₄⁻ that is 0 to 0.05.

In some examples, including any of the foregoing, the electrolyte has a mole ratio of Al₂Cl₇⁻:AlCl₄⁻ of 0.12. In certain examples, the electrolyte has a mole ratio of Al₂Cl₇⁻:AlCl₄⁻ of 0.11. In certain other examples, the electrolyte has a mole ratio of Al₂Cl₇⁻:AlCl₄⁻ of 0.10. In other examples, the electrolyte has a mole ratio of Al₂Cl₇⁻:AlCl₄⁻ of 0.09. In some certain examples, the electrolyte has a mole ratio of Al₂Cl₇⁻:AlCl₄⁻ of 0.08. In yet other examples, the electrolyte has a mole ratio of Al₂Cl₇⁻:AlCl₄⁻ of 0.07. In some examples, the electrolyte has a mole ratio of Al₂Cl₇⁻:AlCl₄⁻ of 0.06. In other examples, the electrolyte has a mole ratio of Al₂Cl₇⁻:AlCl₄⁻ of 0.05. In certain examples, the electrolyte has a mole ratio of Al₂Cl₇⁻:AlCl₄⁻ of 0.04. In yet other examples, the electrolyte has a mole ratio of Al₂Cl₇⁻:AlCl₄⁻ of 0.03. In some examples, the electrolyte has a mole ratio of Al₂Cl₇⁻:AlCl₄⁻ of 0.02. In other examples, the electrolyte has a mole ratio of Al₂Cl₇⁻:AlCl₄⁻ of 0.01. In certain examples, the electrolyte has a mole ratio of Al₂Cl₇⁻:AlCl₄⁻ of 0.

In some examples, including any of the foregoing, the electrolyte has a mole ratio of Al₂Cl₇⁻:AlCl₄⁻ that is 0 to 0.05.

In some examples, including any of the foregoing, the electrolyte has a mole ratio of Al₂Cl₇⁻:AlCl₄⁻ that is 0 to 0.01. In some examples, including any of the foregoing, the electrolyte has a mole ratio of Al₂Cl₇⁻:AlCl₄⁻ that is 0 to 0.011. In some examples, including any of the foregoing, the electrolyte has a mole ratio of Al₂Cl₇⁻:AlCl₄⁻ that is 0 to 0.012. In some examples, including any of the foregoing, the electrolyte has a mole ratio of Al₂Cl₇⁻:AlCl₄⁻ that is 0 to 0.013. In some examples, including any of the foregoing, the electrolyte has a mole ratio of Al₂Cl₇⁻:AlCl₄⁻ that is 0 to 0.014. In some examples, including any of the foregoing, the electrolyte has a mole ratio of Al₂Cl₇⁻:AlCl₄⁻ that is 0 to 0.015. In some examples, including any of the foregoing, the electrolyte has a mole ratio of Al₂Cl₇⁻:AlCl₄⁻ that is 0 to 0.016. In some examples, including any of the foregoing, the electrolyte has a mole ratio of Al₂Cl₇⁻:AlCl₄⁻ that is 0 to 0.017. In some examples, including any of the foregoing, the electrolyte has a mole ratio of Al₂Cl₇⁻:AlCl₄⁻ that is 0 to 0.018. In some examples, including any of the foregoing, the electrolyte has a mole ratio of Al₂Cl₇⁻:AlCl₄⁻ that is 0 to 0.019. In some examples, including any of the foregoing, the electrolyte has a mole ratio of Al₂Cl₇⁻:AlCl₄⁻ that is 0 to 0.02. In some examples, including any of the foregoing, the electrolyte has a mole ratio of Al₂Cl₇⁻:AlCl₄⁻ that is 0 to 0.021. In some examples, including any of the foregoing, the electrolyte has a mole ratio of Al₂Cl₇⁻:AlCl₄⁻ that is 0 to 0.022. In some examples, including any of the foregoing, the electrolyte has a mole ratio of Al₂Cl₇⁻:AlCl₄⁻ that is 0 to 0.023. In some examples, including any of the foregoing, the electrolyte has a mole ratio of Al₂Cl₇⁻:AlCl₄⁻ that is 0 to 0.024. In some examples, including any of the foregoing, the electrolyte has a mole ratio of Al₂Cl₇⁻:AlCl₄⁻ that is 0 to 0.025. In some examples, including any of the foregoing, the electrolyte has a mole ratio of Al₂Cl₇⁻:AlCl₄⁻ that is 0 to 0.026. In some examples, including any of the foregoing, the electrolyte has a mole ratio of Al₂Cl₇⁻:AlCl₄⁻ that is 0 to 0.027. In some examples, including any of the foregoing, the electrolyte has a mole ratio of Al₂Cl₇⁻:AlCl₄⁻ that is 0 to 0.028. In some examples, including any of the foregoing, the electrolyte has a mole ratio of Al₂Cl₇⁻:AlCl₄⁻ that is 0 to 0.029. In some examples, including any of the foregoing, the electrolyte has a mole ratio of Al₂Cl₇⁻:AlCl₄⁻ that is 0 to 0.03. In some examples, including any of the foregoing, the electrolyte has a mole ratio of Al₂Cl₇⁻:AlCl₄⁻ that is 0 to 0.031. In some examples, including any of the foregoing, the electrolyte has a mole ratio of Al₂Cl₇⁻:AlCl₄⁻ that is 0 to 0.032. In some examples, including any of the foregoing, the electrolyte has a mole ratio of Al₂Cl₇⁻:AlCl₄⁻ that is 0 to 0.033. In some examples, including any of the foregoing, the electrolyte has a mole ratio of Al₂Cl₇⁻:AlCl₄⁻ that is 0 to 0.034. In some examples, including any of the foregoing, the electrolyte has a mole ratio of Al₂Cl₇⁻:AlCl₄⁻ that is 0 to 0.035. In some examples, including any of the foregoing, the electrolyte has a mole ratio of Al₂Cl₇⁻:AlCl₄⁻ that is 0 to 0.036. In some examples, including any of the foregoing, the electrolyte has a mole ratio of Al₂Cl₇⁻:AlCl₄⁻ that is 0 to 0.037. In some examples, including any of the foregoing, the electrolyte has a mole ratio of Al₂Cl₇⁻:AlCl₄⁻ that is 0 to 0.038. In some examples, including any of the foregoing, the electrolyte has a mole ratio of Al₂Cl₇⁻:AlCl₄⁻ that is 0 to 0.039. In some examples, including any of the foregoing, the electrolyte has a mole ratio of Al₂Cl₇⁻:AlCl₄⁻ that is 0 to 0.04. In some examples, including any of the foregoing, the electrolyte has a mole ratio of Al₂Cl₇⁻:AlCl₄⁻ that is 0 to 0.041. In some examples, including any of the foregoing, the electrolyte has a mole ratio of Al₂Cl₇⁻:AlCl₄⁻ that is 0 to 0.042. In some examples, including any of the foregoing, the electrolyte has a mole ratio of Al₂Cl₇⁻:AlCl₄⁻ that is 0 to 0.043. In some examples, including any of the foregoing, the electrolyte has a mole ratio of Al₂Cl₇⁻:AlCl₄⁻ that is 0 to 0.044. In some examples, including any of the foregoing, the electrolyte has a mole ratio of Al₂Cl₇⁻:AlCl₄⁻ that is 0 to 0.045. In some examples, including any of the foregoing, the electrolyte has a mole ratio of Al₂Cl₇⁻:AlCl₄⁻ that is 0 to 0.046. In some examples, including any of the foregoing, the electrolyte has a mole ratio of Al₂Cl₇⁻:AlCl₄⁻ that is 0 to 0.047. In some examples, including any of the foregoing, the electrolyte has a mole ratio of Al₂Cl₇⁻:AlCl₄⁻ that is 0 to 0.048. In some examples, including any of the foregoing, the electrolyte has a mole ratio of Al₂Cl₇⁻:AlCl₄⁻ that is 0 to 0.049. In some examples, including any of the foregoing, the electrolyte has a mole ratio of Al₂Cl₇⁻:AlCl₄⁻ that is 0 to 0.05. In some examples, including any of the foregoing, the electrolyte has a mole ratio of Al₂Cl₇⁻:AlCl₄⁻ that is 0 to 0.051. In some examples, including any of the foregoing, the electrolyte has a mole ratio of Al₂Cl₇⁻:AlCl₄⁻ that is 0 to 0.052. In some examples, including any of the foregoing, the electrolyte has a mole ratio of Al₂Cl₇⁻:AlCl₄⁻ that is 0 to 0.053. In some examples, including any of the foregoing, the electrolyte has a mole ratio of Al₂Cl₇⁻:AlCl₄⁻ that is 0 to 0.054. In some examples, including any of the foregoing, the electrolyte has a mole ratio of Al₂Cl₇⁻:AlCl₄⁻ that is 0 to 0.055. In some examples, including any of the foregoing, the electrolyte has a mole ratio of Al₂Cl₇⁻:AlCl₄⁻ that is 0 to 0.056. In some examples, including any of the foregoing, the electrolyte has a mole ratio of Al₂Cl₇⁻:AlCl₄⁻ that is 0 to 0.057. In some examples, including any of the foregoing, the electrolyte has a mole ratio of Al₂Cl₇⁻:AlCl₄⁻ that is 0 to 0.058. In some examples, including any of the foregoing, the electrolyte has a mole ratio of Al₂Cl₇⁻:AlCl₄⁻ that is 0 to 0.059.

In some other examples, set forth herein is an electrochemical cell, comprising: an electrolyte, wherein the electrolyte comprises: (a) AlCl₄¹⁻; (b) Li⁺; and (c) at least one member selected from the group consisting of organic cations and organic-metal complex cations; (d) wherein the electrolyte is free of any Al₂Cl₇¹; (e) wherein the electrolyte is further doped with an additive selected from LiF, Li₂O and combinations thereof. In some examples, the electrolyte is further doped LiF. In some other examples, the electrolyte is further doped with Li₂O.

In some other examples, set forth herein an electrochemical cell, comprising: an electrolyte, wherein the electrolyte comprises: (a) AlCl₄¹⁻; (b) Li⁺; (c) at least one member selected from the group consisting of organic cations and organic-metal complex cations; (d) wherein the electrolyte is free of any Al₂Cl₇¹⁻; (e) wherein the electrolyte is further doped with an additive selected from LiF, Li₂O and combinations thereof; and (f) wherein the electrolyte is made by contacting the electrolyte with aluminum metal in the presence of an additive selected from SnCl₂, GaCl₃, and combinations thereof. In some examples, the process includes contacting and reacting the electrolyte with aluminum metal in the presence of an additive selected from SnCl₂, GaCl₃, and combinations thereof.

In some examples, including any of the foregoing, the metal anode is an Al metal anode or Al metal alloy anode.

In some examples, including any of the foregoing, the metal anode is aluminum (Al).

In some examples, including any of the foregoing, the metal anode is lithium (Li).

In some examples, including any of the foregoing, the metal anode is Al—Li alloy.

In some examples, including any of the foregoing, the metal anode is nickel (Ni).

In some examples, including any of the foregoing, the metal anode is tungsten (W).

In some examples, including any of the foregoing, the metal anode is titanium (Ti).

In some examples, including any of the foregoing, the metal anode is sodium (Na).

In some examples, including any of the foregoing, the metal anode is zinc (Zn).

In some examples, including any of the foregoing, the metal anode is magnesium (Mg).

In some examples, including any of the foregoing, the metal anode is Al—Mg alloy.

In some examples, including any of the foregoing, the metal anode is Al—Zn alloy.

In some examples, including any of the foregoing, the metal anode is Al—Zn—Mg alloy.

In some examples, including any of the foregoing, the metal anode is copper (Cu).

In some examples, including any of the foregoing, the metal anode is Al—Li—Zn alloy.

In some examples, including any of the foregoing, the metal anode is Zn—Al alloy.

In some examples, including any of the foregoing, the metal anode is CuZn alloy.

In some examples, including any of the foregoing, the metal anode is tin (Sn).

In some examples, including any of the foregoing, the electrolyte further comprises at least one species selected from the group consisting of Mg, Zn, Ca, Cu, Na, and combinations thereof, wherein the species are metal species in any of their possible oxidation states. In certain examples, the electrolyte further comprises Mg. In certain examples, the electrolyte further comprises Zn. In certain examples, the electrolyte further comprises Ca. In certain examples, the electrolyte further comprises Cu. In certain examples, the electrolyte further comprises Na. In certain examples, the electrolyte further comprises a combination of Mg, Zn, Ca, Cu, or Na.

In some examples, including any of the foregoing, the species are present at concentrations from 0.1 parts-per-billion (ppb) to 500 parts-per-million (ppm).

In some examples, including any of the foregoing, the species are present at concentrations from 0.1 parts-per-million (ppm) to 1% by mole

In some examples, including any of the foregoing, the electrolyte includes at least one member selected from the group consisting of Mg²⁺, Zn²⁺, Ca²⁺, Cu⁺, Cu²⁺, Na⁺ and combinations thereof. In certain examples, the electrolyte includes Mg²⁺. In certain examples, the electrolyte includes Zn²⁺. In certain examples, the electrolyte includes Ca⁺. In certain examples, the electrolyte includes Cu⁺. In certain examples, the electrolyte includes Na⁺. In certain examples, the electrolyte includes K⁺. In certain examples, the electrolyte includes a combination of Mg²⁺, Zn²⁺, Ca²⁺, Cu⁺, Cu²⁺, K³⁰ , or Na⁺

In some examples, including any of the foregoing, the electrolyte includes at least one member selected from the group consisting of Mg²⁺, Zn²⁺, Ca²⁺, Cu⁺, Cu²⁺, K⁺, Na⁺, and combinations thereof wherein the member is present in the electrolyte at concentrations from 0.1 parts-per-billion (ppb) to 500 parts-per-million (ppm). In certain examples, the electrolyte includes Mg²⁺. In certain examples, the electrolyte includes Zn²⁺. In certain examples, the electrolyte includes Ca²⁺. In certain examples, the electrolyte includes Cu⁺. In certain examples, the electrolyte includes Na⁺. In certain examples, the electrolyte includes K⁺. In certain examples, the electrolyte includes a combination of Mg²⁺, Zn²⁺, Ca²⁺, Cu⁺, Cu²⁺, K⁺, or Na⁺.

In some examples, including any of the foregoing, the electrolyte includes at least one member selected from the group consisting of Mg²⁺, Zn²⁺, Ca²⁺, Cu⁺, Cu²⁺, K⁺ and Na⁺, wherein the member is present in the electrolyte at concentrations less than 0.274 M. In certain examples, the electrolyte includes Mg²⁺. In certain examples, the electrolyte includes Zn²⁺. In certain examples, the electrolyte includes Ca²⁺. In certain examples, the electrolyte includes Cu⁺. In certain examples, the electrolyte includes Na⁺. In certain examples, the electrolyte includes K⁺. In certain examples, the electrolyte includes a combination of Mg²⁺, Zn²⁺, Ca²⁺, Cu⁺, Cu²⁺, K⁺, or Na⁺.

In some examples, including any of the foregoing, the electrolyte includes Li⁺ and Na⁺, wherein the concentration of Na⁺is greater than the concentration of Li^{+.}

In some examples, including any of the foregoing, the electrolyte includes Li⁺. and Na⁺, wherein the concentration of Na⁺is less than the concentration of Li^{+.}

In some examples, including any of the foregoing, the member is present at least at a detectable limit.

In some examples, including any of the foregoing, the amount of Al₂Cl₇¹⁻ is below a detectable limit.

In some examples, including any of the foregoing, the amount of Al₂Cl₇¹⁻ is below a detectable limit as measured by Raman spectroscopy.

In some examples, including any of the foregoing, the amount of Al₂Cl₇¹⁻ is below a detectable limit as measured by mass spectroscopy.

In some examples, including any of the foregoing, the electrolyte includes a saturated amount of a halide of a member selected from the group consisting of Li, Na, Zn, Mg, Ca, Cu, and combinations thereof. In some examples, including any of the foregoing, the electrolyte includes a saturated amount of a halide selected from Li. In some examples, including any of the foregoing, the electrolyte includes a saturated amount of a halide selected from Na. In some examples, including any of the foregoing, the electrolyte includes a saturated amount of a halide selected from Zn. In some examples, including any of the foregoing, the electrolyte includes a saturated amount of a halide selected from Mg. In some examples, including any of the foregoing, the electrolyte includes a saturated amount of a halide selected from Ca. In some examples, including any of the foregoing, the electrolyte includes a saturated amount of a halide selected from Cu.

In some examples, including any of the foregoing, the electrolyte includes a saturated amount of LiCl.

In some examples, including any of the foregoing, the organic cation or organic-metal complex cation comprises imidazolium ions, ammonium ions, pyrrolidinium ions, pyridinium ions, and phosphonium ions.

In some examples, including any of the foregoing, the imidazolium ions include at least one of 1-ethyl-3-methylimidazolium, 1,2-dimethyl-3-propylimidazolium, and combinations thereof.

In some examples, including any of the foregoing, the ammonium ions are selected from benzyltrimethylammonium, trimethylphenylammonium, triethylamine, and combinations thereof.

In some examples, including any of the foregoing, the pyridinium ions include N-(n-butyl) pyridinium.

In some examples, including any of the foregoing, the phosphonium ions include trihexyltetradecylphosphonium.

In some examples, including any of the foregoing, the pyrrolidinium ions include 1-butyl-1-methyl-pyrrolidinium.

In some examples, including any of the foregoing, the organic cation or organic-metal complex cation comprises a compound, or cation derivative thereof, selected from the group consisting of acetamide, urea, methyl urea (MUrea), ethyl urea (EUrea), triethylamine hydrochloride (Et₃NHCl), 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, 1-ethyl-3-methylimidazolium chloride (EMIMC), 4-propylpyridine, N-methylacetamide, N,N-dimethylacetamide, and trimethylphenylammonium chloride.

In some examples, including any of the foregoing, the electrolyte is present at a temperature from −40° C. (233.15 K) to 200° C. (473.15 K).

In some examples, including any of the foregoing, the electrolyte is present at a temperature from −40° C. (233.15 K) to 120° C. (393.15 K).

In some examples, including any of the foregoing, the electrolyte is molten and ionically conductive.

In some examples, including any of the foregoing, the electrolyte comprises less than 100 ppm H₂O.

In some examples, including any of the foregoing, the electrolyte comprises less than 10 ppm H₂O.

In some examples, including any of the foregoing, the electrolyte comprises less than 1 ppm H₂O.

In some examples, including any of the foregoing, the electrolyte comprises less than 100 ppm O₂.

In some examples, including any of the foregoing, the amount of H₂O or the amount of O₂, or both, is below a detectable limit.

In some examples, including any of the foregoing, the electrolyte comprises urea, Murea, Eurea, Et₃NHCl, EMIMC, combinations, and cations thereof.

In some examples, including any of the foregoing, the electrolyte comprises urea or a cation thereof.

In some examples, including any of the foregoing, the electrolyte comprises EMIMC or a cation thereof.

In some examples, including any of the foregoing, the electrolyte comprise AlCl₃:EMIMC in a mole ratio from 1.0 to 2.0.

In some examples, including any of the foregoing, the mole ratio of AlCl₃:EMIMC is 1.0, 1.1, 1.2, 1.3, 1.4, 1.5, 1.6, 1.7, 1.8, 1.9, or 2.0. In some examples, the electrolyte comprises a saturated amount of LiCl.

In some examples, including any of the foregoing, the electrolyte comprises AlCl₃:urea in a mole ratio from 1.0 to 2.0. In some examples, the electrolyte comprises a saturated amount of LiCl.

In some examples, including any of the foregoing, the mole ratio of AlCl₃:urea is 1.0, 1.1, 1.2, 1.3, 1.4, 1.5, 1.6, 1.7, 1.8, 1.9, or 2.0. In some examples, the electrolyte comprises a saturated amount of LiCl.

In some examples, including any of the foregoing, the electrolyte comprise AlCl₃⁻:Murea in a mole ratio from 1.0 to 2.0. In some examples, the electrolyte comprises a saturated amount of LiCl.

In some examples, including any of the foregoing, the mole ratio of AlCl₃⁻:Murea is 1.0, 1.1, 1.2, 1.3, 1.4, 1.5, 1.6, 1.7, 1.8, 1.9, or 2.0. In some examples, the electrolyte comprises a saturated amount of LiCl.

In some examples, including any of the foregoing, the electrolyte comprises AlCl₃⁻:Eurea in a mole ratio from 1.0 to 2.0. In some examples, the electrolyte comprises a saturated amount of LiCl.

In some examples, including any of the foregoing, the mole ratio of AlCl₃⁻:Eurea is 1.0, 1.1, 1.2, 1.3, 1.4, 1.5, 1.6, 1.7, 1.8, 1.9, or 2.0. In some examples, the electrolyte comprises a saturated amount of LiCl.

In some examples, including any of the foregoing, the electrolyte comprises AlCl₃:Et₃NHCl in a mole ratio from 1.0 to 2.0. In some examples, the electrolyte comprises a saturated amount of LiCl.

In some examples, including any of the foregoing, the mole ratio of AlCl₄¹⁻:Et₃NHCl is 1.0, 1.1, 1.2, 1.3, 1.4, 1.5, 1.6, 1.7, 1.8, 1.9, or 2.0. In some examples, the electrolyte comprises a saturated amount of LiCl.

In some examples, including any of the foregoing, the electrolyte comprises: (a) 1.1 to 2.0 molar equivalents AlCl₄¹⁻, (b) 1.0 molar equivalents 1-ethyl-3-methyl imidazolium; and (c) 0.1 to 0.5 molar equivalents 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, or a combination thereof.

In some examples, including any of the foregoing, the electrolyte comprises: (a) an organic cation selected from the group consisting of 1-ethyl-3-methyl imidazolium, N-(n-butyl) pyridinium, benzyltrimethylammonium, 1,2-dimethyl-3-propylimidazolium, trihexyltetradecylphosphonium, and 1-butyl-1-methyl-pyrrolidinium, and (b) an anion selected from the group consisting of chloride, tetrafluoroborate, tri-fluoromethanesulfonate, hexafluorophosphate and bis(trifluoromethanesulfonyl)imide.

In some examples, including any of the foregoing, the electrochemical cell comprises a positive electrode, wherein the positive electrode comprises an active material selected from the group consisting of: LiCoO₂, LiMn₂O₄, LiMn_{1.5}Ni_{0.5}O₄, Li(NiCoAl)O₂ (NCA), Li(NiCoMn)O₂ (NMC), lithium iron phosphate (LiFePO₄), lithium nickel phosphate (LiNiPO₄), lithium cobalt phosphate (LiCoPO₄), lithium manganese phosphate (LiMnPO₄), a lithium cobalt oxide, a lithium manganese cobalt oxide, a lithium nickel manganese cobalt oxide, a lithium nickel manganese oxide and sulfur.

In some examples, including any of the foregoing, the electrochemical cell is in a chemically compatible enclosure.

In some examples, including any of the foregoing, the chemically compatible enclosure comprises a material selected from the group consisting of a hydrophobic polymer, a fluorinated polymer, an aluminum metal, a polymer coated aluminum pouch, and a polymer coated metal container.

In some examples, including any of the foregoing, the electrochemical cell further comprises a positive electrode current collector selected from the group consisting of a glassy carbon, carbon fiber paper, carbon fiber cloth, graphite fiber paper, and graphite fiber cloth.

In some examples, including any of the foregoing, the electrochemical cell further comprises a positive electrode current collector selected from the group consisting of a metal substrate.

In some examples, including any of the foregoing, the metal substrate is a mesh or a foil or a foam.

In some examples, including any of the foregoing, the metal substrate comprises a metal selected from nickel (Ni) or tungsten (W).

In some examples, including any of the foregoing, the metal substrate comprises a metal or alloy coated with a Ni and W thin film.

In some examples, including any of the foregoing, the metal substrate is a Ni foil, a Ni mesh, a W foil, or a W mesh.

In some examples, including any of the foregoing, the metal substrate includes a metal selected from nickel (Ni), stainless steel (SS), iron (Fe) or tungsten (W).

In some examples, including any of the foregoing, the metal substrate includes a metal or alloy coated with a Ni, SS or W thin film.

In some examples, including any of the foregoing, the metal substrate is a Ni foil, a Ni mesh, or a Ni foam, a metal foil with Ni coating, metal mesh with Ni coating, or a metal foam with Ni coating, a W foil, a W foam or a W mesh, a SS foil, a SS foam or a SS mesh.

In some examples, including any of the foregoing, the SS is 304 SS or 304L SS or 316 SS or 316L SS or 201SS.

In some examples, including any of the foregoing, the electrochemical cell further includes a positive electrode, wherein the positive electrode includes a polymer binder and a positive electrode active material, wherein the active material is blended with the polymer binder. In some examples, the polymer binder is a hydrophilic polymer or hydrophobic polymer binder. In some examples, the polymer binder is a hydrophilic polymer and wherein the hydrophilic polymer binder is selected from the group consisting of polyacrylate, polyacrylic acid (PAA), polyvinyl alcohol (PVA), PAA-PVA, polyacrylic latex, cellulose, cellulose derivatives, alginate, acrylonitrile, polyethylene glycol, styrene-butadiene rubber, poly(styrene-co-butadiene), styrene-butadiene rubber, poly(3,4-ethylenedioxythiophene), and combinations thereof.

In some examples, including any of the foregoing, the electrochemical cell includes a separator selected from inorganics such as SiO₂ glass fiber, polymers or inorganic-polymer composites.

In some examples, including any of the foregoing, the electrochemical cell includes a separator, wherein the thickness of the separator is about 20 μm, 50 μm, 100 μm, 150 μm, 200 μm or 400 μm.

In some examples, including any of the foregoing, the electrochemical cell includes AlCl₃:Et₃NHCl in a mole ratio of about 1.7.

In some examples, including any of the foregoing, the molar ratio, mᵣ, of AlCl₃:Et₃NHCl is 1<mᵣ<2.

In some examples, including any of the foregoing, the electrochemical cell includes AlCl₃; Et₃NHCl; a saturated amount of LiCl; 1.0 mol equivalent of Et₃NH⁺; 1.7 mol equivalent of AlCl₄⁻; and 0.7 mol equivalent of Li⁺.

In some examples, including any of the foregoing, the electrochemical cell includes AlCl₃:EMIMC in a mole ratio of about 1.7.

In some examples, including any of the foregoing, the molar ratio, mᵣ, of AlCl₃:EMIMC is 1<mᵣ<2.

In some examples, including any of the foregoing, the electrochemical cell includes AlCl₃; EMIMC; a saturated amount of LiCl; 1.0 mol equivalent of EMIMC; 1.7 mol equivalent of AlCl₄⁻; and 0.7 mol equivalent of Li⁺.

In some examples, including any of the foregoing, the cathode has an active material loading of about 8 to 16 mg/cm².

In some examples, including any of the foregoing, the thickness of the metal anode is about 30 μm.

In some examples, including any of the foregoing, the electrochemical cell includes an Al current negative electrode collector having an Al tab; a SiO₂ glass fiber separator; and a Ni, Ni coated metal, W, SS or C positive electrode current collector having a Ni, Ni coated metal, W, SS, or C tab.

In some examples, including any of the foregoing, the electrochemical cell includes AlCl₃:Et₃NHCl in a mole ratio of about 1.7; a saturated amount of LiCl; 1.0 mol equivalent of Et₃NH⁺; 1.7 mol equivalent of AlCl₄¹⁻; and 0.7 mol equivalent of Li⁺.

In some examples, including any of the foregoing, the cathode has an active material loading of about 16 mg/cm².

In some examples, including any of the foregoing, the thickness of the metal anode is about 30 μm.

In some examples, including any of the foregoing, the electrochemical cell includes aluminum metal or aluminum-lithium alloy negative electrode; an Al current negative electrode collector having an Al tab; a SiO₂ glass fiber separator; a positive electrode comprising an active material selected from the group consisting of: LiCoO₂, LiMn₂O₄, LiMn_{1.5}Ni_{0.5}O₄, Li(NiCoAl)O₂(NCA), Li(NiCoMn)O₂ (NMC), lithium iron phosphate (LiFePO₄), lithium nickel phosphate (LiNiPO₄), lithium cobalt phosphate (LiCoPO₄), lithium manganese phosphate (LiMnPO₄), a lithium cobalt oxide, a lithium manganese cobalt oxide, a lithium nickel manganese cobalt oxide, a lithium nickel manganese oxide and sulfur; and a Ni, Ni coated metal, W, SS, or C positive electrode current collector having a Ni, Ni coated metal, W, SS, or C tab.

In some examples, including any of the foregoing, the thickness of the separator is about 20 μm, 100 μm, 150 μm, or 200 μm.

### Batteries

In some examples, the electrochemical cells or batteries, described herein, are enclosed in a chemically compatible enclosure that includes a material selected from a fluorinated polymer, aluminum metal, and combinations thereof. In some examples, the chemically compatible enclosure includes a fluorinated polymer. In some other examples, the chemically compatible enclosure includes aluminum metal. In certain other examples, the chemically compatible enclosure includes, in addition to a fluorinated polymer, a polyethylene polymer which is not in direct contact with the electrolyte. In some examples, the chemically compatible enclosure includes, in addition to a fluorinated polymer, a polypropylene polymer which is not in direct contact with the electrolyte. In some examples, the chemically compatible enclosure includes combinations of a fluorinated polymer, aluminum metal, polyethylene, and polypropylene, but wherein the polyethylene and polypropylene polymers, when present, are not in direct contact with the electrolyte. In some examples, including any of the foregoing, the fluorinated polymer layer is in contact with the electrolyte. In some examples, including any of the foregoing, the aluminum metal is between the fluorinated polymer layer and another polymer layer, such as a polypropylene layer. Batteries, electrochemical cells, and chemically compatible enclosures as set forth in International PCT/US2018/026968, entitled BATTERY WITH LONG CYCLE LIFE, filed Apr. 14, 2018, are herein incorporated by reference in its entirety for all purposes.

### Processes of Making

In some examples, set forth herein is a process for making an electrolyte, comprising contacting (i) AlCl₃ with (ii) organic cation or organic-metal complex cation, wherein the organic cations are selected from the group consisting of urea ions, imidazolium ions, ammonium ions, pyrrolidinium ions, pyridinium ions, and phosphonium ions; and (iii) a saturated amount of a halide of a member selected from the group consisting of Li, Na, K, Ca, Mg, Zn, Cu, and combinations thereof. Example halides include, but are not limited to, LiCl, NaCl, KCl, Ca₂Cl, Mg₂Cl, Zn₂Cl, CuCl, and Cu₂Cl.

In some other examples, set forth herein is a process for making an electrolyte, wherein the electrolyte comprises: AlCl₄¹⁻; Li⁺; at least one member selected from the group consisting of organic cations and organic-metal complex cations; wherein the electrolyte is free of any Al₂Cl₇¹⁻; and wherein the electrolyte is further doped with an additive of LiF, Li₂O and combinations thereof; the process comprising contacting the electrolyte with aluminum metal in the presence of an additive selected from SnCl₂, GaCl₃, and combinations thereof.

In some examples, including any of the foregoing, the electrolyte is treated by contacting and reacting the electrolyte with aluminum metal in the presence of an additive selected from SnCl₂, GaCl₃, and combinations thereof. In some examples, the electrolyte is further doped with an additive selected from LiF, LiO₂ and combinations thereof. In some examples, the electrolyte is further doped LiF. In some examples, the electrolyte is further doped Li₂O.

In some examples, including any of the foregoing, the electrolyte is treated by contacting and reacting the electrolyte with aluminum metal in the presence SnCl₂. In some examples, the electrolyte is further doped with an additive selected from LiF, LiO₂ and combinations thereof. In some examples, the electrolyte is further doped LiF. In some examples, the electrolyte is further doped Li₂O.

In some examples, including any of the foregoing, the electrolyte is treated by contacting and reacting the electrolyte with aluminum metal in the presence GaCl₃. In some examples, the electrolyte is further doped with an additive selected from LiF, LiO₂ and combinations thereof. In some examples, the electrolyte is further doped LiF. In some examples, the electrolyte is further doped Li₂O.

In some examples, including any of the foregoing, the electrolyte is treated by contacting and reacting the electrolyte with aluminum metal in the presence of combinations of SnCl₂ and GaCl₃. In some examples, the electrolyte is further doped with an additive selected from LiF, LiO₂ and combinations thereof. In some examples, the electrolyte is further doped LiF. In some examples, the electrolyte is further doped Li₂O.

In some other examples, set forth herein is a process for making an electrolyte, comprising contacting (i) AlCl₃ with: (ii) an organic cation or organic-metal complex cation, wherein the organic cation is selected from the group consisting of urea ions, imidazolium ions, ammonium ions, pyrrolidinium ions, pyridinium ions, phosphonium ions, and combinations thereof; and (iii) a saturated amount of a halide of a metal selected from the group consisting of Li, Na, K, Ca, Mg, Zn, Cu, and combinations thereof.

In some examples, including any of the foregoing, the electrolyte is free of any Al₂Cl₇¹⁻, as detected by Raman spectroscopy.

In some examples, including any of the foregoing, the electrolyte is free of any Al₂Cl₇¹⁻, which differs from any previous batteries using Al metal as anode.

In some examples, including any of the foregoing, the process includes reducing the pressure around the electrolyte by drawing a vacuum while cycling the electrolyte at least two or more times in an electrochemical cell.

In some examples, including any of the foregoing, the process includes mixing AlCl₃ and urea, wherein the molar ratio, mᵣ, of AlCl₃:urea is 1<mᵣ<2.

In some examples, including any of the foregoing, the process includes contacting AlCl₃ and urea, wherein the molar ratio, mᵣ, of AlCl₃:urea is 1<mᵣ<2.

In some examples, including any of the foregoing, mᵣ is 1.x, wherein 0<x≤9.

In some examples, including any of the foregoing, the process includes adding x equivalent moles of a halide of Li, Na, K, Ca, Mg, Zn, Cu, and combinations thereof with (i) AlCl₃ with (ii) organic cation or organic-metal complex cation.

In some examples, including any of the foregoing, the process includes adding to a mixture of AlCl₃ and urea x equivalent moles of a halide of Li, Na, K, Ca, Mg, Zn, Cu, and combinations thereof.

In some examples, including any of the foregoing, the process includes adding x equivalent moles of a halide of Li, Na, K, Ca, Mg, Zn, Cu, and combinations thereof.

In some examples, including any of the foregoing, the process includes contacting x equivalent moles of a LiCl with AlCl₃ and an organic cation or organic-metal complex cation.

In some examples, including any of the foregoing, the process includes contacting AlCl₃ and EMIMC, wherein the molar ratio, mᵣ, of AlCl₃:EMIMC is 1<mᵣ<2.

In some examples, including any of the foregoing, mᵣ is 1.x, wherein 0<x≤9.

In some examples, including any of the foregoing, the process includes contacting x equivalent moles of a halide of a member selected from the group consisting of Li, Na, K, Ca, Mg, Zn, Cu, and combinations thereof with AlCl₃ and an organic cation or organic-metal complex cation.

In some examples, including any of the foregoing, the process includes contacting x equivalent moles of a LiCl with AlCl₃ and an organic cation or organic-metal complex cation.

In some examples, including any of the foregoing, the process includes contacting AlCl₃ and triethylamine hydrochloride (Et₃NHCl), wherein the molar ratio, mᵣ, of AlCl₃:Et₃NHCl is 1<mᵣ<2.

In some examples, including any of the foregoing, mᵣ is 1.x, wherein 0<x≤9.

In some examples, including any of the foregoing, the process includes contacting x equivalent moles of a metal or a metal halide of a member selected from the group consisting of Li, Na, K, Ca, Mg, Zn, Cu, and combinations thereof with AlCl₃ and an organic cation or organic-metal complex cation.

In some examples, including any of the foregoing, the process includes contacting x equivalent moles of a LiCl with AlCl₃ and an organic cation or organic-metal complex cation. In some examples, x that is 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20.

In some examples, including any of the foregoing, the process includes contacting the electrolyte with an additive selected from SnCl₂, GaCl₃, and combinations thereof. In some examples, including any of the foregoing, the process includes contacting the electrolyte with SnCl₂. In some examples, including any of the foregoing, the process includes contacting the electrolyte GaCl₃. In some examples, including any of the foregoing, the process includes contacting the electrolyte with a combination of SnCl₂ and GaCl₃. In certain examples, neither SnCl₂, GaCl₃, nor combinations thereof remain in the electrolyte at the end of the process set forth herein. Without being bound by theory, this purification step produces strong color reduction. After this step, the electrochemical cell having this electrolyte demonstrates higher coulombic efficiency.

In some examples, including any of the foregoing, the process includes contacting the electrolyte with SnCl₂.

In some examples, including any of the foregoing, the process includes contacting the electrolyte with GaCl₃.

In some examples, including any of the foregoing, the electrolyte is free of any Al₂Cl₇¹.

In some examples, including any of the foregoing, the halide is a chloride.

In some examples, including any of the foregoing, the halide is LiCl.

In some examples, including any of the foregoing, the electrolyte further includes at least one species selected from the group consisting of Mg, Zn, Ca, Cu, Na, K and combinations thereof, wherein the species are ions in any of their possible oxidation states.

In some examples, including any of the foregoing, the species are present at concentrations from 0.1 parts-per-million (ppm) to 1% by mole.

In some examples, including any of the foregoing, the electrolyte includes at least one species selected from the group consisting of Mg²⁺, Zn²⁺, Ca²⁺, Cu⁺, Cu²⁺, K³⁰ and Na⁺ and combinations thereof.

In some examples, including any of the foregoing, the electrolyte includes at least one species selected from the group consisting of Mg²⁺, Zn²⁺, Ca²⁺, Cu⁺, Cu²⁺, K⁺ and Na⁺, wherein the species is present in the electrolyte at concentrations from 0.1 parts-per-million (ppm) to 1% by mole.

In some examples, including any of the foregoing, the electrolyte includes at least one cation selected from the group consisting of Mg²⁺, Zn²⁺, Ca²⁺, Cu⁺, Cu²⁺, K⁺, Na⁺, and combinations thereof, wherein the cation is present in the electrolyte at concentrations less than 1 M.

In some examples, including any of the foregoing, the electrolyte includes Li⁺ and Na⁺, wherein the concentration of Na⁺ is greater than the concentration of Li⁺.

In some examples, including any of the foregoing, the electrolyte includes Li⁺ and Na⁺, wherein the concentration of Na⁺ is less than the concentration of Li⁺.

In some examples, including any of the foregoing, the cation(s) is present at least at a detectable limit.

In some examples, including any of the foregoing, the amount of Al₂Cl₇¹⁻ is below a detectable limit.

In some examples, including any of the foregoing, the amount of Al₂Cl₇¹⁻ is below a detectable limit as measured by Raman spectroscopy.

In some examples, including any of the foregoing, the amount of Al₂Cl₇¹⁻ is below a detectable limit as measured by mass spectroscopy.

In some examples, including any of the foregoing, the organic cation or organic-metal complex cation comprises a compound, or cation derivative thereof, selected from the group consisting of acetamide, urea, methyl urea (MUrea), ethyl urea (EUrea), triethylamine hydrochloride (Et₃NHCl), 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, 1-ethyl-3-methylimidazolium chloride (EMIMC), 4-propylpyridine, N-methylacetamide, N,N-dimethylacetamide, and trimethylphenylammonium chloride.

In some examples, including any of the foregoing, the electrochemical cell comprises a metal anode comprising a metal, or alloy thereof, selected from the group consisting of aluminum (Al), lithium (Li), zinc (Zn), Al—Li alloy, Zn—Al—Li alloy, nickel (Ni), tungsten (W), titanium (Ti), sodium (Na), tin (Sn). In some examples, including any of the foregoing, the electrochemical cell comprises a metal anode, a cathode, and a separator between the metal anode and the cathode.

In some examples, including any of the foregoing, the electrolyte is present at a temperature from −40° C. (233.15 K) to 200° C. (473.15 K).

In some examples, including any of the foregoing, the electrolyte is present at a temperature from −40° C. (233.15 K) to 120° C. (393.15 K).

In some examples, including any of the foregoing, the process comprises reducing the pressure around the electrolyte by drawing a vacuum while cycling the electrolyte until the electrolyte comprises less than 100 ppm H₂O.

In some examples, including any of the foregoing, the process comprises reducing the pressure around the electrolyte by drawing a vacuum while cycling the electrolyte until the electrolyte comprises less than 10 ppm H₂O.

In some examples, including any of the foregoing, the process comprises reducing the pressure around the electrolyte by drawing a vacuum while cycling the electrolyte until the electrolyte comprises less than 1 ppm H₂O.

In some examples, including any of the foregoing, the process comprises reducing the pressure around the electrolyte by drawing a vacuum while cycling the electrolyte until the electrolyte comprises less than 100 ppm O₂.

In some examples, including any of the foregoing, the organic cation or organic-metal complex cation comprises imidazolium ions, ammonium ions, pyrrolidinium ions, pyridinium ions, and phosphonium ions.

In some examples, including any of the foregoing, the imidazolium ions include at least one of 1-ethyl-3-methylimidazolium, 1,2-dimethyl-3-propylimidazolium, and combinations thereof.

In some examples, including any of the foregoing, the ammonium ions are selected from benzyltrimethylammonium, trimethylphenylammonium, triethylamine, and combinations thereof.

In some examples, including any of the foregoing, the pyridinium ions include N-(n-butyl) pyridinium.

In some examples, including any of the foregoing, the phosphonium ions include trihexyltetradecylphosphonium.

In some examples, including any of the foregoing, the pyrrolidinium ions include 1-butyl-1-methyl-pyrrolidinium.

In some examples, including any of the foregoing, the process comprises cycling the battery for several cycles and reducing the pressure around the electrolyte by drawing a vacuum.

In some examples, including any of the foregoing, the electrolyte is batched with urea, Murea, Eurea, Et₃NHCl, EMIMC, combinations, and cations thereof.

In some examples, including any of the foregoing, the electrolyte is batched with a mixture comprising urea or a cation thereof.

In some examples, including any of the foregoing, the electrolyte is batched with a mixture comprising EMIMC or a cation thereof.

In some examples, including any of the foregoing, the electrolyte is batched with a mixture comprising AlCl₃:EMIMC in a mole ratio from 1.0 to 2.0.

In some examples, including any of the foregoing, the mole ratio of AlCl₃:EMIMC is 1.0, 1.1, 1.2, 1.3, 1.4, 1.5, 1.6, 1.7, 1.8, 1.9, or 2.0. In some examples, including any of the foregoing, the mole ratio of AlCl₃:EMIMC is 1.0. In some examples, including any of the foregoing, the mole ratio of AlCl₃:EMIMC is 1.1. In some examples, including any of the foregoing, the mole ratio of AlCl₃:EMIMC is 1.2. In some examples, including any of the foregoing, the mole ratio of AlCl₃:EMIMC is 1.3. In some examples, including any of the foregoing, the mole ratio of AlCl₃:EMIMC is 1.4. In some examples, including any of the foregoing, the mole ratio of AlCl₃:EMIMC is 1.5. In some examples, including any of the foregoing, the mole ratio of AlCl₃:EMIMC is 1.6. In some examples, including any of the foregoing, the mole ratio of AlCl₃:EMIMC is 1.7. In some examples, including any of the foregoing, the mole ratio of AlCl₃:EMIMC is 1.8. In some examples, including any of the foregoing, the mole ratio of AlCl₃:EMIMC is 1.9. In some examples, including any of the foregoing, the mole ratio of AlCl₃:EMIMC is 2.0.

In some examples, including any of the foregoing, the electrolyte is batched with a mixture comprising AlCl₃: urea in a mole ratio from 1.0 to 2.0. In some examples, including any of the foregoing, the mole ratio of AlCl₃:urea is 1.0. In some examples, including any of the foregoing, the mole ratio of AlCl₃:urea is 1.1. In some examples, including any of the foregoing, the mole ratio of AlCl₃:urea is 1.2. In some examples, including any of the foregoing, the mole ratio of AlCl₃:urea is 1.3. In some examples, including any of the foregoing, the mole ratio of AlCl₃:urea is 1.4. In some examples, including any of the foregoing, the mole ratio of AlCl₃:urea is 1.5. In some examples, including any of the foregoing, the mole ratio of AlCl₃:urea is 1.6. In some examples, including any of the foregoing, the mole ratio of AlCl₃:urea is 1.7. In some examples, including any of the foregoing, the mole ratio of AlCl₃:urea is 1.8. In some examples, including any of the foregoing, the mole ratio of AlCl₃:urea is 1.9. In some examples, including any of the foregoing, the mole ratio of AlCl₃:urea is 2.0.

In some examples, including any of the foregoing, the mole ratio of AlCl₃:Et₃NHCl is 1.0, 1.1, 1.2, 1.3, 1.4, 1.5, 1.6, 1.7, 1.8, 1.9, or 2.0. In some examples, including any of the foregoing, the mole ratio of AlCl₃:Et₃NHCl is 1.0. In some examples, including any of the foregoing, the mole ratio of AlCl₃:Et₃NHCl is 1.1. In some examples, including any of the foregoing, the mole ratio of AlCl₃:Et₃NHCl is 1.2. In some examples, including any of the foregoing, the mole ratio of AlCl₃:Et₃NHCl is 1.3. In some examples, including any of the foregoing, the mole ratio of AlCl₃:Et₃NHCl is 1.4. In some examples, including any of the foregoing, the mole ratio of AlCl₃:Et₃NHCl is 1.5. In some examples, including any of the foregoing, the mole ratio of AlCl₃:Et₃NHCl is 1.6. In some examples, including any of the foregoing, the mole ratio of AlCl₃:Et₃NHCl is 1.7. In some examples, including any of the foregoing, the mole ratio of AlCl₃:Et₃NHCl is 1.8. In some examples, including any of the foregoing, the mole ratio of AlCl₃:Et₃NHCl is 1.9. In some examples, including any of the foregoing, the mole ratio of AlCl₃:Et₃NHCl is 2.0.

In some examples, including any of the foregoing, the mole ratio of AlCl₃:urea is 1.0, 1.1, 1.2, 1.3, 1.4, 1.5, 1.6, 1.7, 1.8, 1.9, or 2.0.

In some examples, including any of the foregoing, the electrolyte is batched with a mixture comprising AlCl₃:MUrea in a mole ratio from 1.0 to 2.0.

In some examples, including any of the foregoing, the mole ratio of AlCl₃:MUrea is 1.0, 1.1, 1.2, 1.3, 1.4, 1.5, 1.6, 1.7, 1.8, 1.9, or 2.0. In some examples, including any of the foregoing, the electrolyte is batched with a mixture comprising AlCl₃:Murea in a mole ratio from 1.0 to 2.0. In some examples, including any of the foregoing, the mole ratio of AlCl₃:Murea is 1.0. In some examples, including any of the foregoing, the mole ratio of AlCl₃:Murea is 1.1. In some examples, including any of the foregoing, the mole ratio of AlCl₃:Murea is 1.2. In some examples, including any of the foregoing, the mole ratio of AlCl₃:Murea is 1.3. In some examples, including any of the foregoing, the mole ratio of AlCl₃:Murea is 1.4. In some examples, including any of the foregoing, the mole ratio of AlCl₃:Murea is 1.5. In some examples, including any of the foregoing, the mole ratio of AlCl₃:Murea is 1.6. In some examples, including any of the foregoing, the mole ratio of AlCl₃:Murea is 1.7. In some examples, including any of the foregoing, the mole ratio of AlCl₃:Murea is 1.8. In some examples, including any of the foregoing, the mole ratio of AlCl₃:Murea is 1.9. In some examples, including any of the foregoing, the mole ratio of AlCl₃:Murea is 2.0.

In some examples, including any of the foregoing, the electrolyte is batched with a mixture comprising AlCl₃:EUrea in a mole ratio from 1.0 to 2.0.

In some examples, including any of the foregoing, the mole ratio of AlCl₃:Eurea is 1.0, 1.1, 1.2, 1.3, 1.4, 1.5, 1.6, 1.7, 1.8, 1.9, or 2.0. In some examples, including any of the foregoing, the electrolyte is batched with a mixture comprising AlCl₃:Eurea in a mole ratio from 1.0 to 2.0. In some examples, including any of the foregoing, the mole ratio of AlCl₃:Eurea is 1.0. In some examples, including any of the foregoing, the mole ratio of AlCl₃:Eurea is 1.1. In some examples, including any of the foregoing, the mole ratio of AlCl₃:Eurea is 1.2. In some examples, including any of the foregoing, the mole ratio of AlCl₃:Eurea is 1.3. In some examples, including any of the foregoing, the mole ratio of AlCl₃:Eurea is 1.4. In some examples, including any of the foregoing, the mole ratio of AlCl₃:Eurea is 1.5. In some examples, including any of the foregoing, the mole ratio of AlCl₃:Eurea is 1.6. In some examples, including any of the foregoing, the mole ratio of AlCl₃:Eurea is 1.7. In some examples, including any of the foregoing, the mole ratio of AlCl₃:Eurea is 1.8. In some examples, including any of the foregoing, the mole ratio of AlCl₃:Eurea is 1.9. In some examples, including any of the foregoing, the mole ratio of AlCl₃:Eurea is 2.0.

In some examples, including any of the foregoing, the electrolyte is batched with a mixture comprising AlCl₃:Et₃NHCl in a mole ratio from 1.0 to 2.0.

In some examples, including any of the foregoing, the mole ratio of AlCl₃:Et₃NHCl is 1.0, 1.1, 1.2, 1.3, 1.4, 1.5, 1.6, 1.7, 1.8, 1.9, or 2.0. In some examples, including any of the foregoing, the mole ratio of AlCl₃:Et₃NHCl is 1.0. In some examples, including any of the foregoing, the mole ratio of AlCl₃:Et₃NHCl is 1.1. In some examples, including any of the foregoing, the mole ratio of AlCl₃: Et₃NHCl is 1.2. In some examples, including any of the foregoing, the mole ratio of AlCl₃: Et₃NHCl is 1.3. In some examples, including any of the foregoing, the mole ratio of AlCl₃: Et₃NHCl is 1.4. In some examples, including any of the foregoing, the mole ratio of AlCl₃: Et₃NHCl is 1.5. In some examples, including any of the foregoing, the mole ratio of AlCl₃: Et₃NHCl is 1.6. In some examples, including any of the foregoing, the mole ratio of AlCl₃: Et₃NHCl is 1.7. In some examples, including any of the foregoing, the mole ratio of AlCl₃: Et₃NHCl is 1.8. In some examples, including any of the foregoing, the mole ratio of AlCl₃:Et₃NHCl is 1.9. In some examples, including any of the foregoing, the mole ratio of AlCl₃:Et₃NHCl is 2.0.

In some examples, set forth herein is an electrolyte made by a process herein.

In some examples, set forth herein is an electrochemical cell that includes an electrolyte made herein.

### EXAMPLES

The Examples herein show how to make and use batteries having a metal anode and the aforementioned electrolyte.

Electrochemical cells in this example included, in separate instances, an Al, Al—Li, Ni, W, Zn, Mg, AlMg, Al—Zn—Mg, Cu, or CuZn metal anode. The AlMg metal anode was an alloy of Al and Mg. The Al—Zn—Mg metal anode was an alloy of Al, Zn, and Mg. The CuZn metal anode was an alloy of Cu and Zn. The Al—Li metal anode was an alloy of Li and Al. The metal anode was washed by ethanol to remove contaminants before use. A 3-mm-wide and 0.09-mm-thick nickel tab was bonded to the cathode which was comprised of lithium iron phosphate (LFP) mixed with conductive carbon and a binder pasted on a nickel foil. Loading of LFP was approximately 10-15 mg/cm². SiO₂ glass fiber filter paper was used as a separator. All of the electrode components were assembled in a pouch. The pouch was made from an aluminum-laminated film. Before filling the electrolyte in the battery pouch, the battery pouch was dried at 80° C. to remove residual moisture.

All electrolytes were made and electrochemical cells assembled in an Argon-filled glovebox with less than about 5 parts-per-million (ppm) water and oxygen in the glovebox. Aluminum Chloride (AlCl₃) (Alfa Aesar, anhydrous 99.9%) was used as received and opened inside the glovebox. 1-ethyl-3-methylimidazolium chloride, urea, and methylurea were vacuum dried at 60-90° C. for 24 hours.

Unless specified to the contrary, all electrochemical cell components inside a pouch were fixed in place using carbon tape, which was exposed to the electrolyte. The carbon tape was used to secure certain parts of the electrochemical cell. However, the carbon tapes is not a necessary component and does not need to be present. A partially assembled cell was dried overnight at 80° C. under vacuum and transferred to the glovebox. In the glovebox, two layers of glass fiber filter paper separator (previously dried at 250° C.) and 1.5 g a 1.3:1 mole ratio of an AlCl₃:urea electrolyte were combined for use as the electrochemical cell separator.

Instruments for electrochemical analysis were CHI 760D (CH Instruments), VMP3 (Bio-Logic) and Battery testing instrument (Neware).

### Physical Analysis

Raman spectra measurement was performed to measure the defect band D band intensity relative to the graphite band G band. The data acquisition time was normally 10 s and accumulated for 10 times. The wavelength of laser excitation source was normalized by a silicon wafer at 520 cm⁻¹. A thermoelectrically cooled charge-coupled device with 1,024×256 pixels operating at 60° C. was used as the detector with 1 cm⁻¹ resolution. The laser line was focused onto the sample using an Olympus×50 objective, and the laser spot size was estimated to be 0.8-1 μm.

Instruments for physical analysis were Bruker D8-advanced (X-ray diffraction measurements) and UniRAM micro-Raman spectrometer with a laser wavelength of 532 nm.

### Example 1—Electrochemical Cells with Aluminum Anodes and Lithium Iron Phosphate Cathodes

This Example shows some of the advantages of using an ionic liquid based electrolyte with Cu²⁺ or Mg²⁺ ion species in an electrochemical cell with a cathode having LiFePO₄ cathode active materials. These advantages should extend to any electrochemical cell with a Li-intercalating positive electrode active material and a negative electrode suitable for use with LiAl-alloy redox active materials, and an electrolyte comprising AlCl₄¹⁻, Li⁺ and optionally Mg²⁺ but wherein the electrolyte is also free of Al₂Cl₇⁻.

Three aluminum-ion batteries (AIB) were prepared. The AIBs each included Al foil as the negative electrode, a 200 μm-thick glass separator with an electrolyte, and LiFePO₄ on Ni foil as positive electrode. The slurry used to deposit the cathode included 85 wt % LiFePO₄, 10 wt % conductive carbon and 5 wt % binder, which was pasted on Ni foil and then dried at 120° C. for 12 hours. The amount of LiFePO₄ in the cathode was approximately 10 mg/cm².

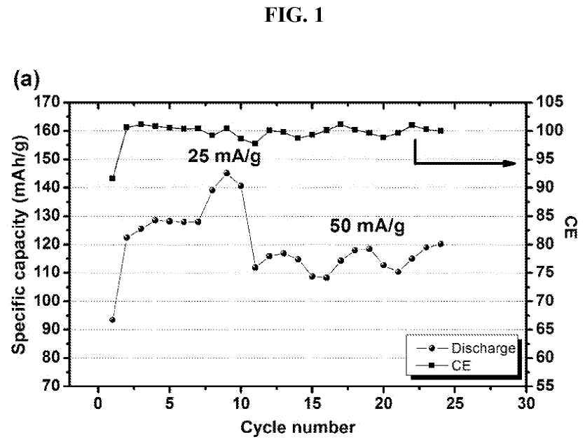

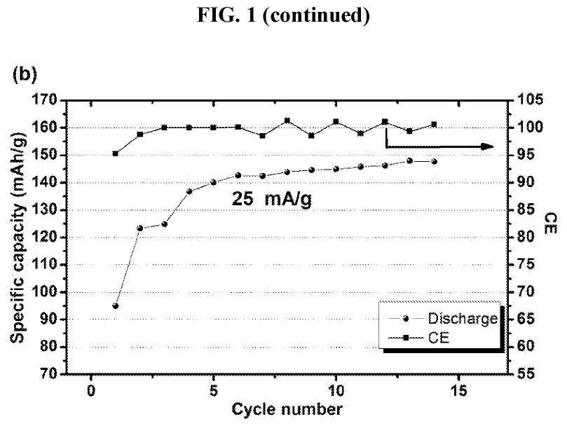

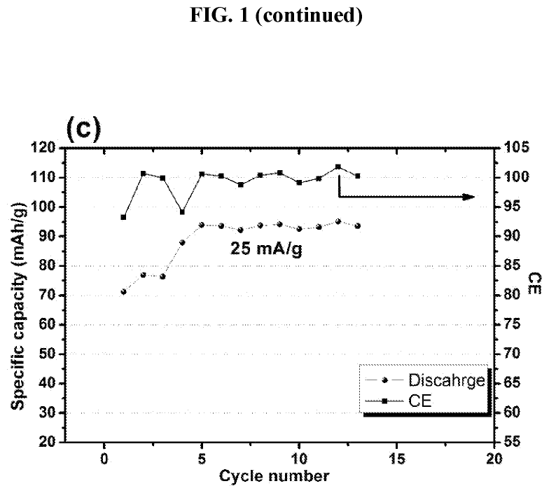

The first electrolyte was prepared by mixing AlCl₃ and EMIMC in a AlCl₃/EMIMC molar ratio of 1.3. EMIMC is 1-ethyl-3-methylimidazolium chloride. Then the electrolyte was exposed to a saturated amount of LiCl. The LiCl was added in an amount to fully neutralize the electrolyte by adding an amount higher than 0.3 equivalent moles, relative to the amount of EMIMC. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An battery with this electrolyte was electrochemically cycled. The results are shown in FIG. 1(a).

The second electrolyte was prepared by mixing AlCl₃ and Et₃NHCl in a AlCl₃:Et₃NHCl molar ratio of 1.7. Then the electrolyte was exposed a saturated amount of LiCl. The LiCl was added in amount to fully neutralize the electrolyte by adding an amount higher than 0.7 equivalent moles, relative to the amount of AlCl₃. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 1(b).

The third electrolyte was prepared by mixing AlCl₃ and Urea in a AlCl₃/Urea molar ratio of 1.3. Then the electrolyte was exposed a saturated amount of LiCl. LiCl was added in an amount to fully neutralize the electrolyte by adding an amount higher than 0.3 equivalent moles, relative to the amount of AlCl₃. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 1(c).

### Example 2—Electrochemical Cells with Aluminum Anodes and Lithium Manganese Nickel Cobalt Oxide Cathodes

The battery composed of aluminum anode and lithium manganese nickel cobalt oxide cathode was prepared. The electrochemical cells included Al foil as the negative electrode, a 200 μm-thick glass separator with an electrolyte, and LiNi_{z}Mn_{y}Co_{z}O₂ (x, y, z range from 0.05-0.95; LiNi_{1/3}Mn_{1/3}Co_{1/3}O₂ used in this example) pasted on Ni foil as positive electrode. The slurry used to prepare the cathode included 85 wt % LiNi_{1/3}Mn_{1/3}CO_{1/3}O₂, 10 wt % conductive carbon and 5 wt % binder, which was pasted on Ni foil and then dried at 120° C. for 12 hours. The mass loading of LiNi_{1/3}Mn_{1/3}CO_{1/3}O₂ in the cathode was approximately 10 mg/cm².

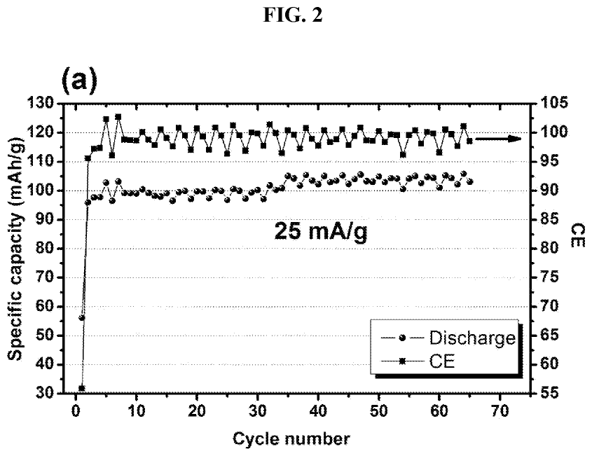

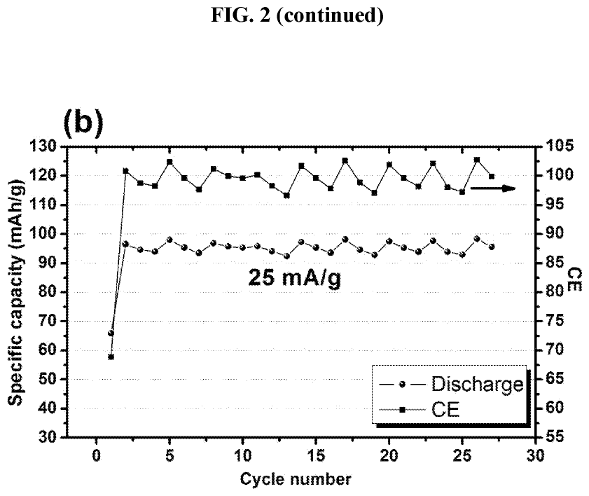

The first electrolyte was prepared by mixing AlCl₃ and EMIMC in a AlCl₃/EMIMC mole ratio of 1.1. Then the electrolyte was exposed to a saturated amount of LiCl. LiCl was added in an amount higher than 0.1 mol equivalents, relative to the amount of AlCl₃, to fully neutralize the electrolyte. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 2(a).

The second electrolyte was prepared by mixing AlCl₃ and Urea in a AlCl₃/Urea mole ratio of 1.3. Then the electrolyte was exposed to a saturated amount of LiCl. LiCl was added in an amount higher than 0.3 mol equivalents, relative to the amount of AlCl₃, to fully neutralize the electrolyte. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 2(b).

### Example 3—Electrochemical Cells with Aluminum Anodes and Graphite Cathodes

Two aluminum-ion batteries (AIB) were prepared. The AIBs each included Al foil as the negative electrode, a 200 μm-thick glass separator with an ionic liquid electrolyte, and graphite-coated Ni foil as positive electrode. The slurry used to prepare the cathode included 95 wt % graphite and 5 wt % binder, which was pasted on Ni foil and then dried at 120° C. for 12 hours. The AIBs each had a different ionic liquid electrolyte (ILE).

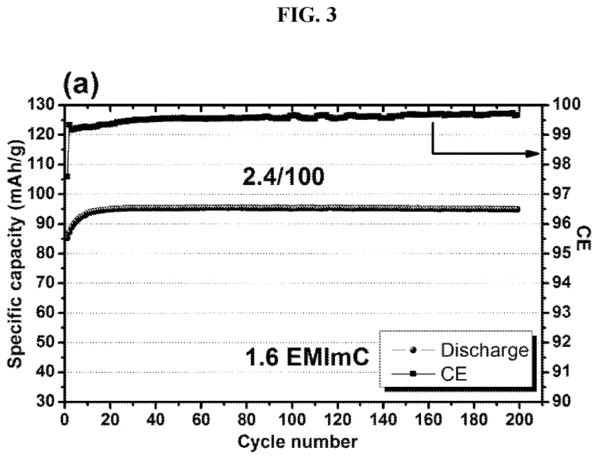

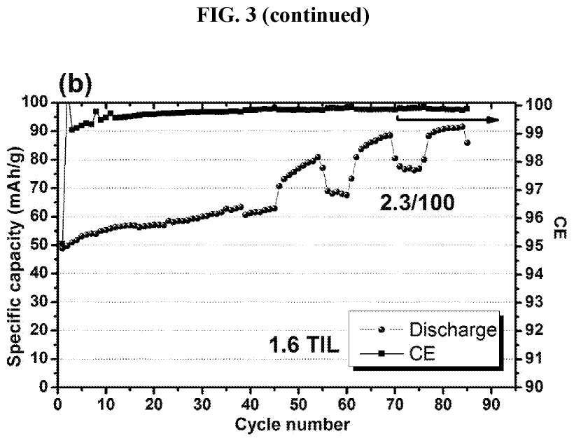

The first electrolyte was prepared by mixing AlCl₃ and EMIC in a AlCl₃/EMIC mole ratio of 1.6. This electrolyte was referred to as an ionic liquid electrolyte (ILE). Then the ILE was exposed to Mg metal which formed Mg²⁺ ions in the ILE in parts-per-million amounts Mg²⁺. The ILE was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. The results are shown in FIG. 3(a).

The second electrolyte was prepared by mixing AlCl₃ and triethylamine hydrochloride (Et₃NHCl) in a AlCl₃/Et₃NHCl mole ratio of 1.6. This electrolyte was referred to as an ionic liquid electrolyte (ILE). Then the ILE was exposed to Cu metal which formed Cu²⁺ ions in the ILE in parts-per-million amounts Cu²⁺. The ILE was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. The results are shown in FIG. 3(b).

### Example 4—Electrochemical Cells with Nickel Anodes and Lithium Iron Phosphate Cathodes

The electrochemical cells in this example included a nickel (Ni) anode and a lithium iron phosphate (LiFePO₄) cathode. The electrochemical cells included Ni foil with a thickness of approximately 20 μm as the negative electrode, a 200 μm-thick glass separator with an electrolyte, and LiFePO₄ on Ni foil as positive electrode. The slurry used to prepare the cathode included 85 wt % LiFePO₄, 10 wt % conductive carbon and 5 wt % binder, which was pasted on Ni foil and then dried at 120° C. for 12 hours. The amount of LiFePO₄ in the cathode was approximately 10 mg/cm².

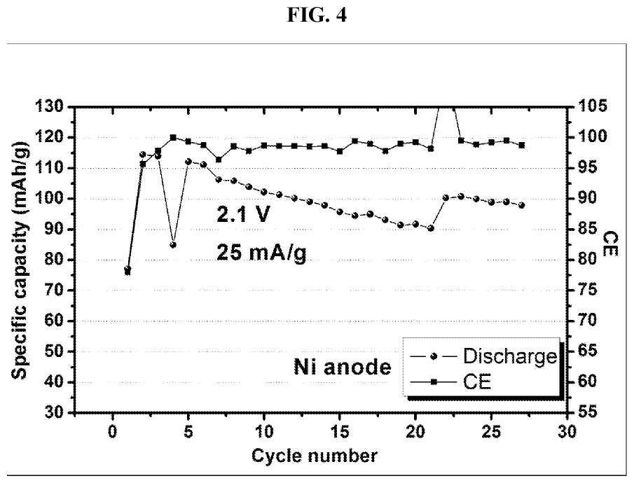

The electrolyte was prepared by mixing AlCl₃ and Et₃NHCl in a AlCl₃/Et₃NHCl mole ratio of 1.7. Then the electrolyte was exposed a saturated amount of LiCl. LiCl in an amount higher than 0.7 mol equivalents, relative to the amount of AlCl₃, was added to fully neutralize the 1.7 AlCl₃/Et₃NHCl electrolyte. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 4.

### Example 5—Electrochemical Cells with Zinc Anodes and Lithium Iron Phosphate Cathodes

The electrochemical cells in this example included a zinc (Zn) anode and lithium iron phosphate (LiFePO₄) cathode. The electrochemical cells included a Zn foil with thickness of 50 μm as the negative electrode, a 200 μm-thick glass separator with an electrolyte, and LiFePO₄ on Ni foil as positive electrode. The slurry used to prepare the cathode included 85 wt % LiFePO4, 10 wt % conductive carbon and 5 wt % binder, which was pasted on Ni foil and then dried at 120° C. for 12 hours. The amount of LiFePO₄ in the cathode was approximately 10 mg/cm².

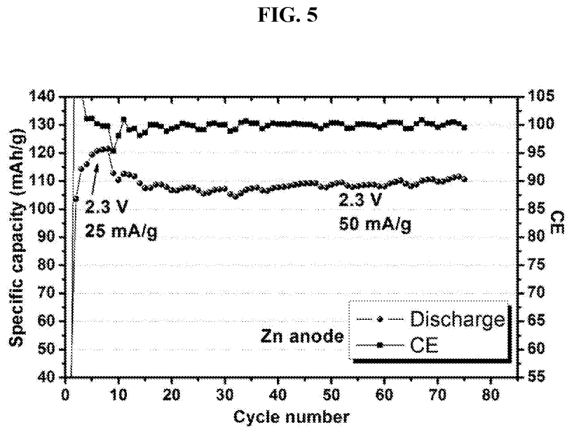

The electrolyte for electrochemical cells with zinc anodes and lithium iron phosphate cathodes was prepared by mixing AlCl₃ and Et₃NHCl in a AlCl₃/Et₃NHCl mole ratio of 1.7. Then the electrolyte was exposed to a saturated amount of LiCl. LiCl in an amount higher than 0.7 mol equivalents, relative to the amount of AlCl₃, was added to fully neutralize the 1.7 AlCl₃/Et₃NHCl electrolyte. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 5.

### Example 6—Electrochemical Cells with Metal Alloy Anodes and Lithium Iron Phosphate Cathodes

The electrochemical cells in this example included an alloy anode and lithium iron phosphate (LiFePO₄) cathode. The electrochemical cells in this example used a metal alloy as anode as demonstrated by Al—Zn—Mg alloy. The 7075 type Al—Zn—Mg alloy (approximately 2.5 wt % Mg, approximately 5.5 wt % Zn, and approximately 92 wt % Al) was used. The electrochemical cells included 7075 type Al—Zn—Mg alloy with thickness of 1.0 mm as the negative electrode, a 200 μm-thick glass separator with an electrolyte, and LiFePO₄ on Ni foil as positive electrode. The amount of LiFePO₄ in the cathode was approximately 10 mg/cm².

The electrolyte for electrochemical cells with an 7075 type Al—Zn—Mg alloy anode and lithium iron phosphate cathodes was prepared by mixing AlCl₃ and Et₃NHCl in a AlCl₃/Et₃NHCl mole ratio of 1.7. Then the electrolyte was exposed to a saturated amount of LiCl. LiCl in an amount higher than 0.7 mol equivalents, relative to the amount of AlCl₃, was added to fully neutralize the 1.7 AlCl₃/Et₃NHCl electrolyte. The electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. An AIB with this electrolyte was electrochemically cycled. The results are shown in FIG. 6.

### Example 7—Raman Spectroscopy Analysis of Electrolyte

An electrolyte was prepared having a mole ratio of AlCl₃:EMIC of 1.1 according to the procedures in Sun, et al., A HIGH PERFORMANCE HYBRID BATTERY BASED ON ALUMINUM ANODE AND LIFEPO₄ CATHODE, Chem. Commun., 2015, DOI: 10.1039/c5cc09019a. The electrolyte included 1 M LiAlCl₄. The electrolyte was analyzed by Raman spectroscopy, the results of which are shown in FIG. 7.

The results in FIG. 7 show that the electrolyte was not fully neutralized. Al₂Cl₇⁻ species was observed at 316 cm⁻¹ based on Raman spectroscopy. Analysis of this electrolyte showed a mole ratio of Al₂Cl₇⁻:AlCl₄⁻ of approximately 0.122.

### Example 8—Raman Spectroscopy Analysis of Electrolyte

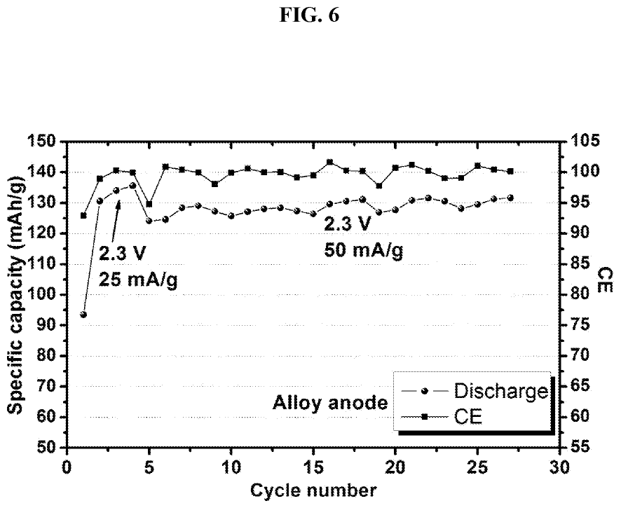

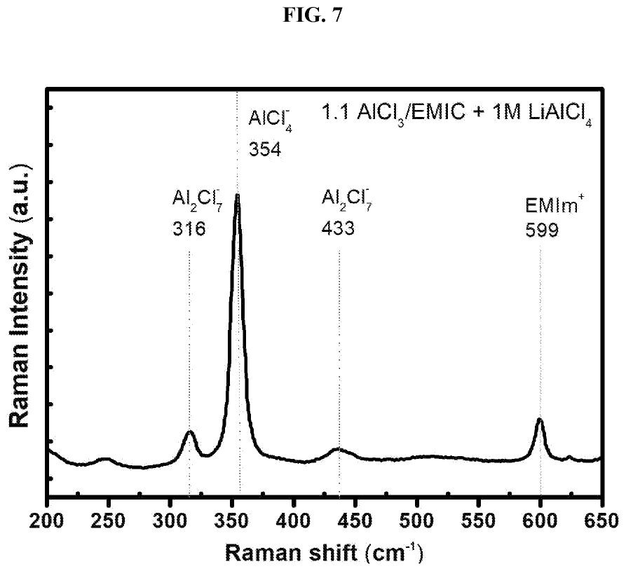

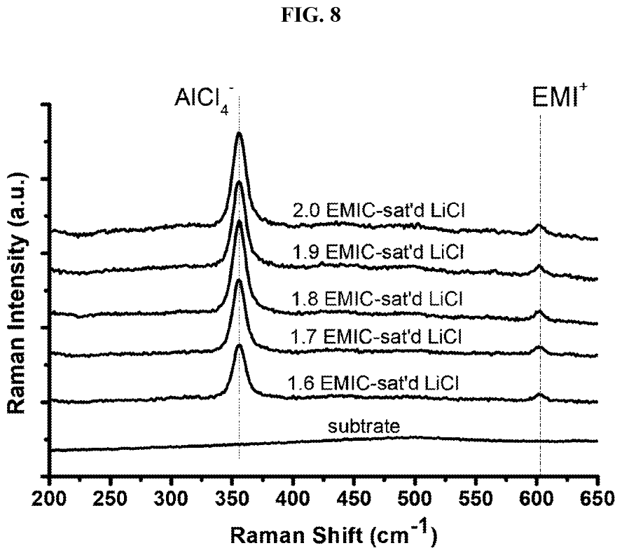

A series of electrolytes were prepared by mixing AlCl₃ and EMIMC in AlCl₃/EMIMC molar ratios of 1.6, 1.7, 1.8, 1.9, and 2.0. EMIMC is 1-ethyl-3-methylimidazolium chloride. Each electrolyte was exposed to a saturated amount of LiCl. Each electrolyte was then purified under vacuum according to the methods set forth in International PCT/US2018/026968, entitled BATTERY WITH LONG CYCLE LIFE, filed Apr. 14, 2018, the entire contents of which are herein incorporated by reference in its entirety for all purposes. The series of electrolytes was analyzed by Raman spectroscopy, the results of which are shown in FIG. 8.

The results in FIG. 8 show that the electrolyte was fully neutralized. No amount of Al₂Cl₇⁻ species were observed.

### Example 9—Comparison of Electrochemical Cells Having Neutralized and not Neutralized Electrolytes

The electrolyte from Example 7 was used in a first electrochemical cell. The first electrochemical cell included an aluminum anode that was 400 μm thick, and a cathode that included LiFePO₄ (1-2 mg/cm² loading) with LA133 binder.

The electrolyte from Example 8 having a mole ratio of AlCl₃/EMIMC of 1.6 was used in a second electrochemical cell. The second electrochemical cell included an aluminum anode that was 400 μm thick, and a cathode that included LiFePO₄ (8 mg/cm² loading) with LA133 binder.

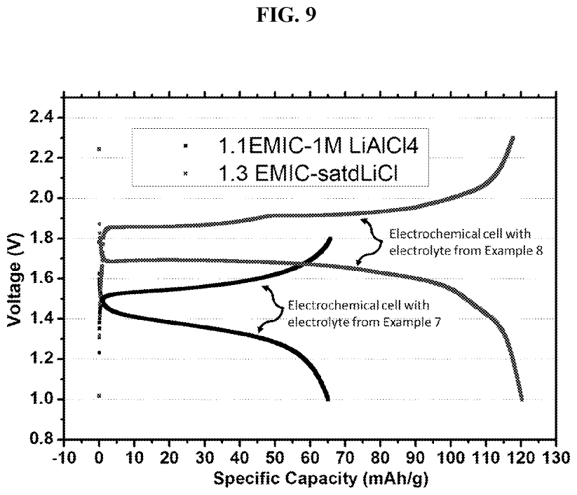

The first electrochemical cell was electrochemically cycled. The results are shown in the bottom plot in FIG. 9.

The second electrochemical cell was electrochemically cycled. The results are shown in the top plot in FIG. 9.

The second electrochemical cell demonstrated a higher discharge plateau of 1.7. The first electrochemical cell demonstrated a lower discharge plateau of 1.3 V. These results demonstrate that the second electrochemical cell operated according a different anode than the first electrolyte. This is due, in part, because the electrolyte in the second electrochemical cell did not include any Al₂Cl₇⁻ species, whereas the electrolyte in the first electrochemical cell did include Al₂Cl₇⁻ species. Without being bound by theory, the second electrochemical cell operated by a Li—Al alloy redox reaction. Without being bound by theory, the first electrochemical cell operated by an Al redox reaction.

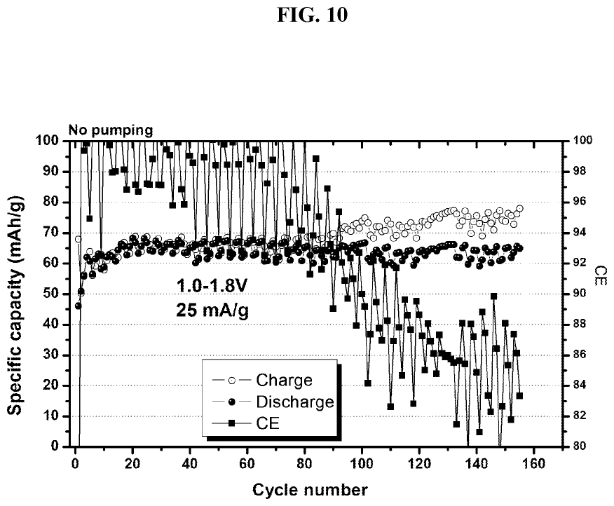

The first electrochemical cell was electrochemically cycled for about one hundred sixty (160) cycles. After about ninety (90) cycles, the coulombic efficiency noticeably decays. The results are shown in FIG. 10.

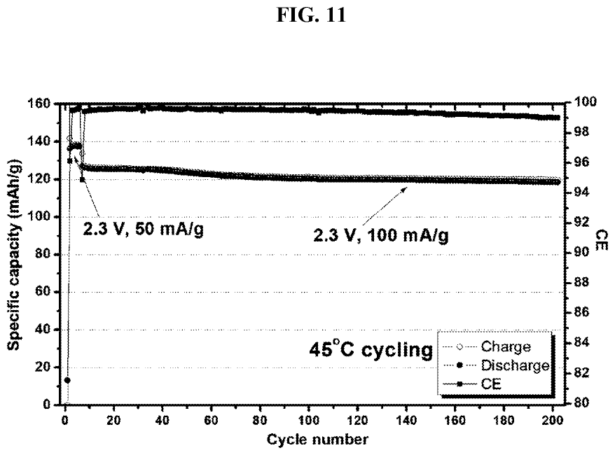

The second electrochemical cell was electrochemically cycled for about one hundred sixty (160) cycles. After about ninety (90) cycles, the coulombic efficiency remained greater than 99%. The results are shown in FIG. 11.

### Example 10—X-Ray Photoelectron Spectroscopy (XPS) and Scanning Electron Microscopy (Sem) Analysis of Li—Al Anode

The electrolyte from Example 8 having a mole ratio of AlCl₃/EMIMC of 1.6 was used in an electrochemical cell. The electrolyte included a mole ratio of AlCl₃/EMIC equal to 1.6, and the electrolyte was neutralized with 0.6 molar ratio LiCl. The electrochemical cell included an aluminum anode that was 400 μm thick, and a cathode that included LiFePO₄ (8 mg/cm² loading) with LA133 binder.

The electrochemical cell was de-assembled from its charged state after 10 charge-discharge cycles.

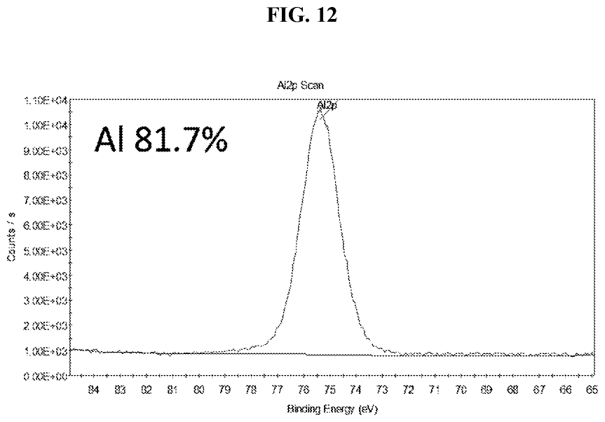

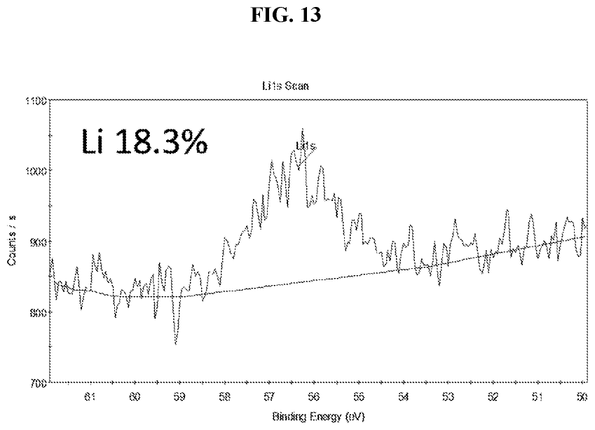

XPS analysis of the anode after 10 charge-discharge cycles is shown in FIGS. 12 and 13.

FIG. 12 shows an XPS signature characteristic of 81.7% Al.

FIG. 13 shows an XPS signature characteristic of 18.3% Li.

FIGS. 12 and 13 demonstrate that the electrochemical cell operated by a Li—Al alloy redox reaction, as also described in Example 9.

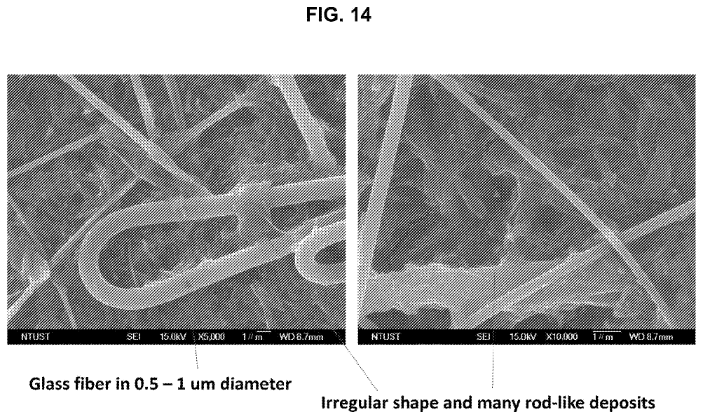

SEM analysis also shows a morphology characteristic of the products of a Li—Al alloy redox reaction. The results are shown in FIG. 14.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical cell, comprising:
(i) an electrolyte, wherein the electrolyte comprises:
(a) AlCl₄¹⁻;
(b) Li⁺; and
(c) at least one member selected from the group consisting of organic cations and organic-metal complex cations;
(d) at least one member selected from the group consisting of LiF, Li₂O, and combinations thereof; and
(d) wherein the electrolyte is free of any Al₂Cl₇¹⁻ as detected by Raman spectroscopy;
(ii) a metal anode comprising a metal, or alloy thereof, selected from the group consisting of aluminum (Al), lithium (Li), Al—Li alloy, nickel (Ni), tungsten (W), titanium (Ti), sodium (Na), zinc (Zn), Al—Zn alloy, Al—Li—Zn alloy, copper (Cu), and tin (Sn); and
(iii) a cathode, wherein the cathode is redox-active to at least one intercalation species selected from the group consisting of Li⁺, Na⁺, K⁺, and AlCl₄¹⁻.

2. The electrochemical cell of claim 1, wherein the metal anode is an Al anode or an Al alloy anode.

3. The electrochemical cell of claim 1 or 2, wherein the electrolyte further comprises at least one species selected from the group consisting of Mg, Zn, Ca, Cu, Na, K and combinations thereof, wherein the species are ions in any of their possible oxidation states.

4. The electrochemical cell of claim 3, wherein the species are present at concentrations from 0.1 parts-per-million (ppm) to 1% by mole.

5. The electrochemical cell of any one of claims 3-4, comprising at least one species selected from the group consisting of Mg²⁺, Zn²⁺, Ca²⁺, Cu⁺, Cu²⁺, K⁺ and Na⁺ and combinations thereof.

6. The electrochemical cell of any one of claims 3-5, comprising at least one species selected from the group consisting of Mg²⁺, Zn²⁺, Ca⁺, Cu⁺, Cu⁺, K⁺ and Na⁺, wherein the species is present in the electrolyte at concentrations from 0.1 parts-per-million (ppm) to 1% by mole.

7. The electrochemical cell of any one of claims 3-6, comprising at least one cation selected from the group consisting of Mg²⁺, Zn²⁺, Ca²⁺, Cu⁺, Cu²⁺, K⁺ and Na⁺, wherein the cation is present in the electrolyte at concentrations less than 1 M.

8. The electrochemical cell of any one of claims 3-7, comprising Li⁺ and Na⁺, wherein the concentration of Na⁺ is greater than the concentration of Li⁺.

9. The electrochemical cell of any one of claims 3-7, comprising Li⁺ and Na⁺, wherein the concentration of Na⁺ is less than the concentration of Li⁺.

10. The electrochemical cell of claim 7, 8 or 9, wherein the cation(s) is (are) present at least at a detectable limit.

11. The electrochemical cell of any one of claims 1-10, wherein the amount of Al₂Cl₇¹⁻ is below a detectable limit.

12. The electrochemical cell of claim 11, wherein the amount of Al₂Cl₇¹⁻ is below a detectable limit as measured by Raman spectroscopy.

13. The electrochemical cell of claim 11 or 12, wherein the amount of Al₂Cl₇¹⁻ is below a detectable limit as measured by mass spectroscopy.

14. The electrochemical cell of any one of claims 1-13, further comprising a saturated amount of a halide of a member selected from the group consisting of Li, K, Na, Zn, Mg, Ca, Cu and combinations thereof.

15. The electrochemical cell of claim 14, wherein the halide is chloride.

16. The electrochemical cell of any one of claims 1-13, further comprising a saturated amount of LiCl.

17. The electrochemical cell of any one of claims 1-16, wherein the organic cation or organic-metal complex cation comprises metal cations coordinated with at least one of acetamide, urea, methyl urea (MUrea), ethyl urea (EUrea), 4-propylpyridine, N-methylacetamide, N,N-dimethylacetamide, and combinations thereof.

18. The electrochemical cell of any one of claims 1-17, wherein the organic cation or organic-metal complex cation comprises imidazolium ions, ammonium ions, pyrrolidinium ions, pyridinium ions, and phosphonium ions.

19. The electrochemical cell of claim 18, wherein the imidazolium ions comprise at least one of 1-ethyl-3-methylimidazolium, 1,2-dimethyl-3-propylimidazolium, and combinations thereof.

20. The electrochemical cell of claim 18, wherein the ammonium ions are selected from benzyltrimethylammonium, trimethylphenylammonium, triethylamine, and combinations thereof.

21. The electrochemical cell of claim 18, wherein the pyridinium ions comprise N-(n-butyl) pyridinium.

22. The electrochemical cell of claim 18, wherein the phosphonium ions comprise trihexyltetradecylphosphonium.

23. The electrochemical cell of claim 18, wherein the pyrrolidinium ions comprise 1-butyl-1-methyl-pyrrolidinium.

24. The electrochemical cell of any one of claims 1-23, wherein the electrolyte is an ionic liquid present at a temperature from −40° C. (233.15 K) to 200° C. (473.15 K).

25. The electrochemical cell of any one of claims 1-24, wherein the electrolyte comprises an organic solvent and is present at a temperature from −20° C. (233.15 K) to 80° C. (393.15 K).

26. The electrochemical cell of claim 24 or 25, wherein the electrolyte is molten and ionically conductive.

27. The electrochemical cell of any one of claims 1-26, wherein the electrolyte comprises less than 100 ppm H₂O.

28. The electrochemical cell of any one of claims 1-27, wherein the electrolyte comprises less than 10 ppm H₂O.

29. The electrochemical cell of any one of claims 1-28, wherein the electrolyte comprises less than 1 ppm H₂O.

30. The electrochemical cell of any one of claims 1-29, wherein the electrolyte comprises less than 100 ppm O₂.

31. The electrochemical cell of any one of claims 1-30, wherein the amount of H₂O or the amount of O₂, or both, is below a detectable limit.

32. The electrochemical cell of any one of claims 1-31, wherein the electrolyte comprises cations of urea, Murea or Eurea.

33. The electrochemical cell of any one of claims 1-32, wherein the electrolyte comprises urea, Murea or Eurea ligands.

34. The electrochemical cell of any one of claims 1-33, wherein the electrolyte comprises organic cations of ammonium, imidazolium, and combinations thereof.

35. The electrochemical cell of claim 34, wherein the organic cations of ammonium comprises cations of triethylamine.

36. The electrochemical cell of claim 34, wherein the organic cations of imidazolium comprise 1-ethyl-3-methylimidazolium (EMIM⁺).

37. The electrochemical cell of any one of claims 1-36, wherein the electrolyte comprises urea or a cation thereof.

38. The electrochemical cell of any one of claims 1-37, wherein the electrolyte comprises EMIMC or a cation thereof.

39. The electrochemical cell any one of claims 1-38, wherein the electrolyte comprise AlCl₃:EMIMC in a mole ratio from 1.0 to 2.0.

40. The electrochemical cell of claim 39, wherein the mole ratio of AlCl₃:EMIMC is 1.0, 1.1, 1.2, 1.3, 1.4, 1.5, 1.6, 1.7, 1.8, 1.9, or 2.0.

41. The electrochemical cell any one of claims 1-38, wherein the electrolyte comprises AlCl₄¹⁻:urea in a mole ratio from 1.0 to 2.0.

42. The electrochemical cell of claim 41, wherein the mole ratio of AlCl₄¹⁻:urea is 1.0, 1.1, 1.2, 1.3, 1.4, 1.5, 1.6, 1.7, 1.8, 1.9, or 2.0.

43. The electrochemical cell of any one of claims 1-38, wherein the electrolyte comprise AlCl₃:MUrea in a mole ratio from 1.0 to 2.0.

44. The electrochemical cell of claim 43, wherein the mole ratio of AlCl₃:MUrea is 1.0, 1.1, 1.2, 1.3, 1.4, 1.5, 1.6, 1.7, 1.8, 1.9, or 2.0.

45. The electrochemical cell of any one of claims 1-38, wherein the electrolyte comprises AlCl₃:EUrea in a mole ratio from 1.0 to 2.0.

46. The electrochemical cell of claim 45, wherein the mole ratio of AlCl₃:Eurea is 1.0, 1.1, 1.2, 1.3, 1.4, 1.5, 1.6, 1.7, 1.8, 1.9, or 2.0.

47. The electrochemical cell of any one of claims 1-46, wherein the electrolyte comprises AlCl₃:Et₃NHCl in a mole ratio from 1.0 to 2.0.

48. The electrochemical cell of claim 47, wherein the mole ratio of AlCl₃:Et₃NHCl is 1.0, 1.1, 1.2, 1.3, 1.4, 1.5, 1.6, 1.7, 1.8, 1.9, or 2.0.

49. The electrochemical cell of any one of claims 11-48, wherein the electrolyte further comprises at least one species selected from the group consisting of Mg, Zn, Ca, Cu, Na, K and combinations thereof, wherein the species are ions in any of their possible oxidation states.

50. The electrochemical cell of claim 49, wherein the species are present at concentrations from 0.1 parts-per-million (ppm) to 1% by mole.

51. The electrochemical cell of any one of claims 11-50, comprising at least one species selected from the group consisting of Mg⁺, Zn²⁺, Ca⁺, Cu⁺, Cu⁺, K⁺ and Na⁺ and combinations thereof.

52. The electrochemical cell of any one of claims 11-51, comprising at least one species selected from the group consisting of Mg²⁺, Zn²⁺, Ca²⁺, Cu⁺, Cu²⁺, K⁺ and Na⁺, wherein the species is present in the electrolyte at concentrations from 0.1 parts-per-million (ppm) to 1% by mole.

53. The electrochemical cell of any one of claims 1-52, comprising at least one cation selected from the group consisting of Mg²⁺, Zn²⁺, Ca²⁺, Cu⁺, Cu²⁺, K⁺ and Na⁺, wherein the cation is present in the electrolyte at concentrations less than 1 M.

54. The electrochemical cell of any one of claims 11-53, comprising Li⁺ and Na⁺, wherein the concentration of Na⁺ is greater than the concentration of Li⁺

55. The electrochemical cell of any one of claims 11-54, comprising Li⁺ and Na⁺, wherein the concentration of Na⁺ is less than the concentration of Li⁺.

56. The electrochemical cell of claim 51, 52, or 53, wherein the cation(s) is present at least at a detectable limit.

57. The electrochemical cell any one of claims 1-56, wherein the cathode comprises a material redox-active towards AlCl₄⁻ ions or Li⁺ ions.

58. The electrochemical cell any one of claims 1-57, wherein the cathode comprises at least one of group consisting of graphite, sulfur (S), LiCoO₂, LiMn₂O₄, LiMn_{1.5}Ni_{0.5}O₄, Li(NiCoAl)O₂ (NCA), Li(NiCoMn)O₂ (NMC), lithium iron phosphate (LiFePO₄), lithium nickel phosphate (LiNiPO₄), lithium cobalt phosphate (LiCoPO₄), lithium manganese phosphate (LiMnPO₄), a lithium cobalt oxide, a lithium manganese cobalt oxide, a lithium nickel manganese cobalt oxide, a lithium nickel manganese oxide and sulfur.

59. The electrochemical cell of claim 58, wherein the electrochemical cell is in a chemically compatible enclosure.

60. The electrochemical cell of claim 59, wherein the chemically compatible enclosure comprises a material selected from the group consisting of a hydrophobic polymer, a fluorinated polymer, an aluminum metal, a polymer coated aluminum pouch, and a polymer coated metal container.

61. The electrochemical cell of any one of claims 1-60, wherein the electrochemical cell further comprises a cathode current collector selected from the group consisting of a glassy carbon, carbon fiber paper, carbon fiber cloth, graphite fiber paper, and graphite fiber cloth.

62. The electrochemical cell of any one of claims 1-60, wherein the electrochemical cell further comprises a cathode current collector selected from the group consisting of a metal substrate.

63. The electrochemical cell of claim 62, wherein the metal substrate is a mesh or a foil or a foam.

64. The electrochemical cell of claim 62 or 63, wherein the metal substrate comprises a metal selected from nickel (Ni), stainless steel (SS), iron (Fe) or tungsten (W).

65. The electrochemical cell of claim 62 or 63, wherein the metal substrate comprises a metal or alloy coated with a Ni, SS or W thin film.

66. The electrochemical cell of claim 62 or 63, wherein the metal substrate is a Ni foil, a Ni mesh, a Ni foam, a W foil, a W foam, or a W mesh, a SS foil a SS foam or a SS mesh.

67. The electrochemical cell of any one of claims 64-66, wherein the SS is 304 SS, 304L SS, 316 SS, 316L SS, 201SS.

68. The electrochemical cell of any one of claims 62-67, wherein positive electrode comprises a polymer binder and a positive electrode active material, wherein the active material is blended with the polymer binder.

69. The electrochemical cell of claim 68, wherein polymer binder is a hydrophilic polymer or hydrophobic polymer binder.

70. The electrochemical cell of claim 68, wherein polymer binder is a hydrophilic polymer selected from the group consisting of polyacrylate, polyacrylic acid (PAA), polyvinyl alcohol (PVA), PAA-PVA, polyacrylic latex, cellulose, cellulose derivatives, alginate, acrylonitrile, acrylonitrile multi copolymer, polyethylene glycol, styrene-butadiene rubber, poly(styrene-co-butadiene), styrene-butadiene rubber, poly(3,4-ethylenedioxythiophene), and combinations thereof.

71. The electrochemical cell of any one of claims 1-70, wherein the electrochemical cell comprises a separator selected from SiO₂ glass fiber, polymers, fluorinated polymers and inorganic-polymer composites.

72. The electrochemical cell of any one of claims 1-71, wherein the electrochemical cell comprises a separator, wherein the thickness of the separator is about 20 μm, 50 μm, 100 μm, 150 μm, 200 μm or 400 μm.

73. The electrochemical cell of 1-72, wherein the electrochemical cell comprises AlCl₃:Et₃NHCl in a mole ratio of about 1.7.

74. The electrochemical cell of claim 73, wherein the molar ratio, mᵣ, of AlCl₃:Et₃NHCl is 1<mᵣ<2.

75. The electrochemical cell of 1-73, wherein the electrochemical cell comprises AlCl₃;
Et₃NHCl;
a saturated amount of LiCl;
1.0 mol equivalent of Et₃NH⁺;
1.7 mol equivalent of AlCl₄⁻; and
0.7 mol equivalent of Li⁺.

76. The electrochemical cell of 1-72, wherein the electrochemical cell comprises AlCl₃: EMIMC in a mole ratio of about 1.7.

77. The electrochemical cell of claim 76, wherein the molar ratio, mᵣ, of AlCl₃:EMIMC is 1<mᵣ<2.

78. The electrochemical cell of 1-77, wherein the electrochemical cell comprises AlCl₃;
EMIMC;
a saturated amount of LiCl;
1.0 mol equivalent of EMIM⁺;
1.7 mol equivalent of AlCl₄⁻; and
0.7 mol equivalent of Li⁺.

79. The electrochemical cell of any one of claims 1-78, wherein the cathode has an active material loading of about 8 to 16 mg/cm².

80. The electrochemical cell of any one of claims 1-79, wherein the thickness of the metal anode is about 30 μm.

81. The electrochemical cell of claim 1, comprising:
an Al current negative electrode collector having an Al tab;
a SiO₂ glass fiber separator;
and a Ni, Ni-coated metal, W, SS or C positive electrode current collector having a Ni, Ni-coated metal, W, SS, or C tab.

82. A process for making an electrolyte, comprising
(i) contacting AlCl₃ with:
(ii) organic cation or organic-metal complex cation, wherein the organic cations are selected from the group consisting of urea ions, imidazolium ions, ammonium ions, pyrrolidinium ions, pyridinium ions, and phosphonium ions; and
(iii) a saturated amount of a halide of a member selected from the group consisting of Li, Na, K, Ca, Mg, Zn, Cu, and combinations thereof.

83. The process of claim 82, wherein the electrolyte is free of any Al₂Cl₇¹⁻.

84. The process of claim 82 or 83, comprising reducing the pressure around the electrolyte by drawing a vacuum while cycling the electrolyte at least two or more times in an electrochemical cell.

85. The process of any one of claims 82-85, comprising contacting AlCl₃ and urea, wherein the molar ratio, mᵣ, of AlCl₃:urea is 1<mᵣ<2.

86. The process of claim 85, wherein mᵣ is 1.x, wherein 0<x≤9.

87. The process of claim 86, comprising contacting x equivalent moles of a halide of a member selected from the group consisting of Li, Na, K, Ca, Mg, Zn, Cu, and combinations thereof with (i) and (ii).

88. The process of claim 85 or 86, comprising contacting x equivalent moles of a LiCl with (i) and (ii).

89. The process of any one of claims 82-88, comprising contacting AlCl₃ and EMIMC, wherein the molar ratio, mᵣ, of AlCl₃:EMIMC is 1<mᵣ<2.

90. The process of claim 89, wherein mᵣ is 1.x, wherein 0<x≤9.

91. The process of claim 90, comprising contacting x equivalent moles of a halide of a member selected from the group consisting of Li, Na, K, Ca, Mg, Zn, Cu, and combinations thereof with (i) and (ii).

92. The process of claim 90 or 91, comprising contacting x equivalent moles of a LiCl with (i) and (ii).

93. The process of any one of claims 82-85, comprising contacting AlCl₃ and triethylamine hydrochloride (Et₃NHCl), wherein the molar ratio, mᵣ, of AlCl₃:Et₃NHCl is 1<mᵣ<2.

94. The process of claim 93, wherein mᵣ is 1.x, wherein 0<x≤9.

95. The process of claim 94, comprising contacting x equivalent moles of a halide of a member selected from the group consisting of Li, Na, K, Ca, Mg, Zn, Cu, and combinations thereof with (i) and (ii).

96. The process of claim 93 or 94, comprising contacting x equivalent moles of a LiCl with (i) and (ii).

97. The process of any one of claims 82-96, wherein the electrolyte is free of any Al₂Cl₇¹⁻.

98. The process of any one of claims 82-97, wherein the halide is a chloride.

99. The process of any one of claims 82-98, wherein the halide is LiCl.

100. The process of any one of claims 82-99, wherein the electrolyte further comprises at least one species selected from the group consisting of Mg, Zn, Ca, Cu, Na, K and combinations thereof, wherein the species are ions in any of their possible oxidation states.

101. The process of claim 100, wherein the species are present at concentrations from 0.1 parts-per-million (ppm) to 1% by mole.

102. The process of any one of claims 82-101, wherein the electrolyte comprises at least one species selected from the group consisting of Mg²⁺, Zn²⁺, Ca²⁺, Cu⁺, Cu²⁺, K⁺ and Na⁺ and combinations thereof.

103. The process of any one of claims 82-102, wherein the electrolyte comprises at least one species selected from the group consisting of Mg²⁺, Zn²⁺, Ca²⁺, Cu⁺, Cu²⁺, K⁺ and Na⁺, wherein the species is present in the electrolyte at concentrations from 0.1 parts-per-million (ppm) to 1% by mole.

104. The process of any one of claims 82-103, wherein the electrolyte comprises at least one cation selected from the group consisting of Mg²⁺, Zn²⁺, Ca²⁺, Cu⁺, Cu²⁺, K⁺ and Na⁺, wherein the cation is present in the electrolyte at concentrations less than 1 M.

105. The process of any one of claims 82-104, wherein the electrolyte comprises Li⁺ and Na⁺, wherein the concentration of Na⁺ is greater than the concentration of Li⁺.

106. The process of any one of claims 82-105, wherein the electrolyte comprises Li⁺ and Na⁺, wherein the concentration of Na⁺ is less than the concentration of Li⁺

107. The process of any one of claims 82-106, wherein the cation(s) is present at least at a detectable limit.

108. The process of any one of claims 82-107, wherein the amount of Al₂Cl₇¹⁻ is below a detectable limit.

109. The process of any one of claims 82-108, wherein the amount of Al₂Cl₇¹⁻ is below a detectable limit as measured by Raman spectroscopy.

110. The process of any one of claims 82-109, wherein the amount of Al₂Cl₇¹⁻ is below a detectable limit as measured by mass spectroscopy.

111. The process of any one of claims 82-110, wherein the electrochemical cell comprises a metal anode comprising a metal, or alloy thereof, selected from the group consisting of aluminum (Al), lithium (Li), Al—Li alloy, nickel (Ni), tungsten (W), titanium (Ti), sodium (Na), zinc (Zn), Zn—Al—Li alloy, Al—Zn alloy, copper (Cu), and tin (Sn).

112. The process of any one of claims 82-111, wherein the electrochemical cell comprises a metal anode, a cathode, and a separator between the metal anode and the cathode.

113. The process of any one of claims 82-112, wherein the electrochemical is operable between −20 to 100° C.

114. The process of claim 102, wherein the species are present at concentrations from 0.1 parts-per-billion (ppb) to 500 parts-per-million (ppm).

115. The process of claim 102, wherein the species are present at concentrations less than 0.274 M.

116. The process of any one of claims 82-115, wherein the organic cation or organic-metal complex cation comprises metal cations coordinated with at least one of acetamide, urea, methyl urea (MUrea), ethyl urea (EUrea), 4-propylpyridine, N-methylacetamide, N,N-dimethylacetamide, and combinations thereof.

117. The process of any one of claims 82-116, wherein the organic cation or organic-metal complex cation comprises imidazolium ions, ammonium ions, pyrrolidinium ions, pyridinium ions, and phosphonium ions.

118. The process of claim 117, wherein the imidazolium ions comprise at least one of 1-ethyl-3-methylimidazolium, 1,2-dimethyl-3-propylimidazolium, and combinations thereof.

119. The process of claim 117, wherein the ammonium ions are selected from benzyltrimethylammonium, trimethylphenylammonium, triethylamine, and combinations thereof.

120. The process of claim 117, wherein the pyridinium ions comprise N-(n-butyl) pyridinium.

121. The process of claim 117, wherein the phosphonium ions comprise trihexyltetradecylphosphonium.

122. The process of claim 117, wherein the pyrrolidinium ions comprise 1-butyl-1-methyl-pyrrolidinium.

123. The process of any one of claims 82-122, wherein the electrolyte is an ionic liquid present at a temperature from −40° C. (233.15 K) to 200° C. (473.15 K).

124. The process of any one of claims 82-123, wherein the electrolyte comprises an organic solvent and is present at a temperature from −20° C. (233.15 K) to 80° C. (393.15 K).

125. The process of any one of claims 82-124, wherein the electrolyte is molten and ionically conductive.

126. The process of any one of claims 82-125, wherein the electrolyte comprises less than 100 ppm H₂O.

127. The process of any one of claims 82-126, wherein the electrolyte comprises less than 10 ppm H₂O.

128. The process of any one of claims 82-127, wherein the electrolyte comprises less than 1 ppm H₂O.

129. The process of any one of claims 82-128, wherein the electrolyte comprises less than 100 ppm O₂.

130. The process of any one of claims 82-129, wherein the amount of H₂O or the amount of O₂, or both, is below a detectable limit.

131. The process of any one of claims 82-130, wherein the electrolyte comprises cations of urea, Murea or Eurea.

132. The process of any one of claims 82-131, wherein the electrolyte comprises urea, Murea or Eurea ligands.

133. The process of any one of claims 82-132, wherein the electrolyte comprises organic cations of ammonium, imidazolium, and combinations thereof.

134. The process of claim 133, wherein the organic cations of ammonium comprises cations of triethylamine.

135. The process of claim 133, wherein the organic cations of imidazolium comprise 1-ethyl-3-methylimidazolium (EMIM⁺).

136. The process of any one of claims 82-135, wherein the electrolyte comprises urea or a cation thereof.

137. The process of any one of claims 82-136, wherein the electrolyte comprises EMIM⁺ or a cation thereof.

138. The process of claim 137, wherein the electrolyte comprise AlCl₃:EMIMC in a mole ratio from 1.0 to 2.0.

139. The process of claim 138, wherein the mole ratio of AlCl₃:EMIMC is 1.0, 1.1, 1.2, 1.3, 1.4, 1.5, 1.6, 1.7, 1.8, 1.9, or 2.0.

140. The process any one of claims 82-136, wherein the electrolyte comprises AlCl₃:urea in a mole ratio from 1.0 to 2.0.

141. The process of claim 140, wherein the mole ratio of AlCl₃:urea is 1.0, 1.1, 1.2, 1.3, 1.4, 1.5, 1.6, 1.7, 1.8, 1.9, or 2.0.

142. The process of any one of claims 82-136, wherein the electrolyte comprise AlCl₃:MUrea in a mole ratio from 1.0 to 2.0.

143. The process of claim 142, wherein the mole ratio of AlCl₃:MUrea is 1.0, 1.1, 1.2, 1.3, 1.4, 1.5, 1.6, 1.7, 1.8, 1.9, or 2.0.

144. The process of any one of claims 82-136, wherein the electrolyte comprises AlCl₃:EUrea in a mole ratio from 1.0 to 2.0.

145. The process of claim 144, wherein the mole ratio of AlCl₃:Eurea is 1.0, 1.1, 1.2, 1.3, 1.4, 1.5, 1.6, 1.7, 1.8, 1.9, or 2.0.

146. The process of any one of claims 82-136, wherein the electrolyte comprises AlCl₃:Et₃NHCl in a mole ratio from 1.0 to 2.0.

147. The process of claim 146, wherein the mole ratio of AlCl₃:Et₃NHCl is 1.0, 1.1, 1.2, 1.3, 1.4, 1.5, 1.6, 1.7, 1.8, 1.9, or 2.0.

148. The process of any one of claims 82-146, wherein the electrolyte further comprises at least one species selected from the group consisting of Mg, Zn, Ca, Cu, Na, K and combinations thereof, wherein the species are ions in any of their possible oxidation states.

149. The process of claim 147, wherein the species are present at concentrations from 0.1 parts-per-million (ppm) to 1% by mole.

150. The process of any one of claims 82-149, comprising at least one species selected from the group consisting of Mg²⁺, Zn²⁺, Ca²⁺, Cu⁺, Cu²⁺, K⁺ and Na⁺ and combinations thereof.

151. The process of any one of claims 82-150, comprising at least one species selected from the group consisting of Mg²⁺, Zn²⁺, Ca²⁺, Cu⁺, Cu²⁺, K³⁰ and Na⁺, wherein the species is present in the electrolyte at concentrations from 0.1 parts-per-million (ppm) to 1% by mole.

152. The process of any one of claims 82-151, comprising at least one cation selected from the group consisting of Mg²⁺, Zn²⁺, Ca²⁺, Cu⁺, Cu²⁺, K⁺ and Na⁺, wherein the cation is present in the electrolyte at concentrations less than 1 M.

153. The process of any one of claims 82-152, comprising Li⁺ and Na⁺, wherein the concentration of Na⁺ is greater than the concentration of Li⁺.

154. The process of any one of claims 82-152, comprising Li⁺ and Na⁺, wherein the concentration of Na⁺ is less than the concentration of Li⁺.

155. The process of any one of claims 152-154, wherein the cation(s) is present at least at a detectable limit.

156. The process of any one of claims 82-155, wherein the amount of Al₂Cl₇¹⁻ is below a detectable limit.

157. The process of any one claims 82-156, wherein the amount of Al₂Cl₇¹⁻ is below a detectable limit as measured by Raman spectroscopy.

158. The process of any one of claims 82-156, wherein the amount of Al₂Cl₇¹⁻ is below a detectable limit as measured by mass spectroscopy.

159. The process of any one of claims 82-156, wherein the organic cation or organic-metal complex cation comprises a compound, or cation derivative thereof, selected from the group consisting of acetamide, urea, methyl urea (MUrea), ethyl urea (EUrea), triethylamine hydrochloride (Et₃NHCl), 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, 1-ethyl-3-methylimidazolium chloride (EMIMC), 4-propylpyridine, N-methylacetamide, N,N-dimethylacetamide, and trimethylphenylammonium chloride.

160. The process of any one of claims 82-159, comprising reducing the pressure around the electrolyte by drawing a vacuum while cycling the electrolyte until the electrolyte comprises less than 100 ppm H₂O.

161. The process of any one of claims 82-159, comprising reducing the pressure around the electrolyte by drawing a vacuum while cycling the electrolyte cycling the electrolyte until the electrolyte comprises less than 10 ppm H₂O.

162. The process of any one of claims 82-159, comprising reducing the pressure around the electrolyte by drawing a vacuum while cycling the electrolyte cycling the electrolyte until the electrolyte comprises less than 1 ppm H₂O.

163. The process of any one of claims 82-159, comprising reducing the pressure around the electrolyte by drawing a vacuum while cycling the electrolyte cycling the electrolyte until the electrolyte comprises less than 100 ppm O₂.

164. The process of any one of claims 82-159, comprising reducing the pressure around the electrolyte by drawing a vacuum while cycling the electrolyte cycling the electrolyte until the electrolyte comprises an amount of H₂O or the amount of O₂, or both, below a detectable limit.

165. The process of any one of claims 82-164, further comprising contacting the electrolyte with aluminum metal in the presence of an additive selected from SnCl₂, GaCl₃, and combinations thereof.

166. The process of claim 165, wherein the process comprises contacting the electrolyte with aluminum metal in the presence of SnCl₂.

167. The process of claim 165, wherein the process comprises contacting the electrolyte with aluminum metal in the presence of GaCl₃.

168. The process of claim 165, wherein the process comprises contacting the electrolyte with aluminum metal in the presence of SnCl₂ and GaCl₃.

169. An electrolyte made by the process of any one of claims 82-168.

170. An electrochemical cell comprising the electrolyte of claim 169.

171. A battery comprising:
a positive electrode;
a metal or metal alloy negative electrode; and
an electrolyte of claim 168.
